(19) United States
(12) Patent Application Publication
(10) Pub. No.: US 2025/0378552 A1
(43) Pub. Date: Dec. 11, 2025

(54) STAIN-FREE, RAPID, AND QUANTITATIVE VIRAL PLAQUE ASSAY USING DEEP LEARNING AND HOLOGRAPHY

(71) Applicant: THE REGENTS OF THE UNIVERSITY OF CALIFORNIA, Oakland, CA (US)

(72) Inventors: Aydogan Ozcan, Los Angeles, CA (US); Yuzhu Li, Los Angeles, CA (US); Tairan Liu, Los Angeles, CA (US)

(73) Assignee: THE REGENTS OF THE UNIVERSITY OF CALIFORNIA, Oakland, CA (US)

(21) Appl. No.: 18/877,188

(22) PCT Filed: Jun. 23, 2023
(86) PCT No.: PCT/US2023/068967

§ 371 Date: Dec. 19, 2024

Related U.S. Application Data
(60) Provisional application No. 63/356,976, filed on Jun. 29, 2022.

(51) Int. Cl. G06T 7/00; G01N 1/30; G06T 7/11; G06T 7/136

(52) U.S. Cl. CPC G06T 7/0012; G01N 1/30; G06T 7/11; G06T 7/136; G01N 2001/302; G06T 2207/20084

(57) ABSTRACT

A stain-free quantitative viral plaque assay device uses lens-free holographic imaging and deep learning to quickly detect the plaque formations. The device captures phase and/or amplitude information of the plaque formations in contained within wells or sample-holding regions of sample holder in a label-free manner. The device uses a trained neural network to automatically detect the cell lysing events due to viral replication as early as 5 hours or earlier after the incubation, and achieved >90% detection rate for the plaque-forming units (PFUs) with 100% specificity in <20 hours, providing major time savings compared to the traditional plaque assays that take ≥48 hours. This data-driven plaque assay also offers the capability of quantifying the infected area of the cell monolayer, performing automated counting and quantification of PFUs and virus-infected areas over a 10-fold larger dynamic range of virus concentration than standard viral plaque assays.

### RELATED APPLICATION

This Application claims priority to U.S. Provisional Patent Application No. 63/356,976 filed on Jun. 29, 2022, which is hereby incorporated by reference. Priority is claimed pursuant to 35 U.S.C. § 119 and any other applicable statute.

### STATEMENT REGARDING FEDERALLY SPONSORED RESEARCH AND DEVELOPMENT

This invention was made with government support under Grant Number 2034234, awarded by the National Science Foundation. The government has certain rights in the invention.

### TECHNICAL FIELD

The technical field generally relates to viral plaque assays. More specifically, the technical field relates to an automated viral plaque assay that is a rapid and stain-free quantitative viral plaque assay using lens-free holographic imaging and deep learning. This cost-effective, compact, and automated device significantly reduces the incubation time needed for traditional plaque assays while preserving their advantages over other virus quantification methods.

### BACKGROUND

Viral infections pose significant global health challenges by affecting millions of people worldwide through infectious diseases, such as influenza, human immunodeficiency virus (HIV), human papillomavirus (HPV), and others. The US Centers for Disease Control and Prevention (CDC) estimates that, since 2010, the influenza virus has resulted in 16-53 million illnesses, 0.2-1 million hospitalizations, and 16,700-66,000 deaths in the United States alone. Furthermore, the ongoing COVID-19 pandemic has already caused >500 million infections and >6 million deaths worldwide, bringing a huge burden on public health and socioeconomic development. To cope with these global health challenges, developing an accurate and low-cost virus quantification technique is crucial to clinical diagnosis, vaccine development, and the production of recombinant proteins or antiviral agents.

Plaque assay was developed as the first method for quantifying virus concentrations in 1952 and was advanced by Renato Dulbecco, where the number of plaque-forming units (PFUs) was manually determined in a given sample containing replication-competent lytic virions. These samples are serially diluted, and aliquots of each dilution are added to a dish of cultured cells. As the virus infects adjacent cells and spreads, a plaque will gradually form, which can be visually inspected by an expert. Due to its unique capability of providing the infectivity of the viral samples in a cost-effective way, the plaque assay remains to be the gold standard method for quantifying virus concentrations despite the presence of other methods such as the immunofluorescence focal forming assays (FFA), polymerase chain reaction (PCR), and enzyme-linked immunoassay (ELISA) based assays. However, plaque assays usually need an incubation period of 2-14 days (depending on the type of virus and culture conditions) to let the plaques expand to visible sizes, and are subject to human errors during the manual plaque counting process. To improve the traditional plaque assays, numerous methods have been developed. While these earlier systems have unique capabilities to image cell cultures in well plates, they require either fluorescence markers or special culture plates with gold microelectrodes. In addition, human counting errors still remain to be a problem for these methods. Hence, an accurate, quantitative, automated, rapid, and cost-effective plaque assay is urgently needed in virology research and related clinical applications.

Some of the recent developments in quantitative phase imaging (QPI), holography, and deep learning provide an opportunity to address this need. QPI is a preeminent imaging technique that enables the visualization and quantification of transparent biological specimens in a non-invasive and label-free manner. Furthermore, the image quality of QPI systems can be enhanced using neural networks by improving e.g., phase retrieval, noise reduction, auto-focusing, and spatial resolution. In addition, numerous deep learning-based microorganism detection and identification methods have been successfully demonstrated using QPI.

### SUMMARY

In one embodiment, a cost-effective and compact label-free live plaque assay device is disclosed that can automatically provide substantially faster quantitative PFU readout than traditional viral plaque assays without the need for staining. A compact lens-free holographic imaging prototype was built to image the spatiotemporal features of the target PFUs during their incubation and the total cost of the parts of this entire imaging system is <$880, excluding a standard laptop computer. This lens-free holographic imaging system rapidly scans the entire area of a 6-well plate every hour (at a throughput of ˜0.32 Giga-pixels per scan of a test well), and the reconstructed phase images of the sample are used for PFU detection based on the spatiotemporal changes observed within the wells. A neural network-based classifier was trained and used to convert the reconstructed phase images to PFU probability maps, which were then used to reveal the locations and sizes of the PFUs within the well plate(s). To prove the efficacy of the system, early detection of vesicular stomatitis virus (VSV), herpes simplex virus type 1 (HSV−1), and encephalonmyocarditis virus (EMCV) were was performed on Vero E6 cell plates. The stain-free device could automatically detect the first cell-lysing event due to the VSV replication as early as 5 hours or earlier after the incubation and achieve >90% PFU detection rate in <20 hours, providing major time savings compared to the traditional plaque assays that take ≥48 hours. Furthermore, an average incubation time saving of ˜48 hours and ˜20 hours was demonstrated for HSV-1 and EMCV, respectively, achieving a PFU detection rate >90% with 100% specificity. A quantitative relationship was also developed between the incubated virus concentration and the virus-infected area on the cell monolayer. Without any extra sample preparation steps, this deep learning-enabled label-free PFU imaging and quantification device can be used with various plaque assays in virology and might help to expedite vaccine and drug development research.

In one embodiment, a device for performing an automated viral plaque assay of a sample includes a sample holder including one or more wells or sample-holding regions formed therein and configured to incubate the sample with cells contained in the one or more wells or sample-holding regions; one or more illumination sources disposed on one side of the sample holder and configured to illuminate the sample holder; one or more image sensors disposed on an opposing side of the sample holder and configured to capture holographic images of the one or more wells or sample-holding regions over a plurality of incubation times, wherein the one or more image sensors and/or the sample holder is/are moveable relative to one another; and a computing device executing image processing software configured to reconstruct the holographic images into phase and/or amplitude images, the image processing software further including a trained neural network configured receive the phase and/or amplitude images obtained over the plurality of incubation times and generate an output PFU image identifying plaque-forming units (PFUs) and/or virus-infected areas for the one or more wells or sample-holding regions.

In another embodiment, a method of performing an automated viral plaque assay with a sample including providing a sample holder including one or more wells or sample-holding regions formed therein containing cells incubated with the sample; illuminating the sample holder with one or more illumination sources at a plurality of different incubation times; capturing holographic images of the one or more wells or sample-holding regions over the plurality of incubation times with one or more image sensors disposed on an opposing side of the sample holder as the one or more illumination sources; and executing image processing software configured to reconstruct the holographic images into phase and/or amplitude images that are input into a trained neural network configured receive the phase and/or amplitude images over the plurality of incubation times and generate an output PFU image identifying plaque-forming units (PFUs) and/or virus-infected areas for the one or more wells or sample-holding regions.

### BRIEF DESCRIPTION OF THE DRAWINGS

FIGS. 1A-IC illustrate the stain-free, rapid and quantitative viral plaque assay device that uses deep learning and lens-less holography. FIG. 1A: photograph of the stain-free PFU imaging device that captures the phase images of the plaque assay at a throughput of ˜0.32 Giga-pixels per scan of each test well. The processing of each test well using the PFU classifier network takes ˜7.5 min/well, automatically converting the holographic phase images of the well into a PFU probability map (see FIGS. 2A-2F). FIG. 1B: detailed illustration of the system components. FIG. 1C: a 6-well plate sample with ventilation holes on the cover and parafilm sealed from the side.

FIG. 1D schematically illustrates a printed circuit board (PCB) and components contained thereon for operation of the device as well as the computing device that interfaces with the microcontroller on the PCB. The computing device includes image processing software that contains the trained neural network and automatic control program.

FIG. 2 illustrates the schematics of the workflow of the label-free viral plaque assay and its comparison to the standard PFU assay. Operation (a): plaque assay sample preparation workflow. The traditional plaque assay at the last step in (a) is only performed for comparison purposes and is not needed for the operation of the presented PFU detection device. Operations (b)-(f) illustrate the detailed image and data processing steps for the live viral plaque assay.

FIGS. 3A-3C illustrate the performance of the stain-free plaque assay device for samples with low virus concentration. FIG. 3A: whole well comparison of the stain-free viral plaque assay after 15-h incubation against the traditional plaque assay after 48-h incubation and staining. FIG. 3B: the growth of three featured PFUs in the positive well from FIG. 3A. The reconstructed phase channel is overlaid with the mask generated using the PFU localization algorithm to reveal their locations better. FIG. 3C: average PFU detection rate using the label-free viral plaque assay. The error bars show the standard deviation across the 5 testing plates.

FIGS. 4A-4C illustrate the performance of the stain-free viral plaque assay as a function of the virus concentration. FIGS. 4A-4B: whole plate comparison of the stain-free viral plaque assay after 15-h incubation against the traditional plaque assay after 48-h incubation and staining. FIG. 4C: the growth of PFUs in their early stage for the same plate shown in FIG. 4A and FIG. 4B.

FIGS. 5A-5C illustrate the quantitative performance analyses of the label-free viral plaque assay for high virus concentration samples. FIG. 5A: PFU counting results for different high concentration virus samples at different time points. The shaded region indicates the time when the PFUs were heavily clustered and no longer suitable for counting. FIG. 5B: area of the virus-infected regions for different high virus concentration samples at different time points. The error bars in (A-B) show the standard error across 5 titer testing plates. FIG. 5C: plots of virus dilution factor vs. the ratio of the infected cell area per test well (in %) for all 5 titer test samples at 6, 8, and 10 h of incubation time.

FIGS. 6A-6B are graphs of infected area percentage (%) measured by the stain-free device at different time points (12 h—FIG. 6A and 15 h—FIG. 6B) vs. the virus concentration per well (PFU/mL). The virus concentrations in y-axis were obtained from the 48-h traditional plaque assay for each test well. Different test wells of the same plate were marked with the same color/symbols. There are 25 infected test wells in each plot. The solid calibration curves were obtained by quadratic polynomial fitting.

FIG. 7: Graphical user interface of the imaging system control program. Users can adjust, for example, the illumination, image sensor, and scan settings through this user interface. Real time images are also displayed.

FIGS. 8A and 8B illustrates the 15-h and 20-h PFU detection results of the positive well shown in FIG. 3A against the 48-h staining results of the traditional plaque assay. FIG. 8A illustrates the detection results at 15 hours of the positive well shown in FIG. 3A against its 48-h stained ground truth. FIG. 8B illustrates the detection results at 20 hours of the positive well shown in FIG. 3A against its 48-h stained ground truth. The dots label the centers of the PFUs detected/counted by the system.

FIGS. 9A-9C illustrate the effect of different decision thresholds used in generating the final PFU detection results. FIG. 9A is a visual comparison of VSV PFU detection results using a decision threshold ranging from 0.1 to 0.9 with a step size of 0.2. FIG. 9B shows averaged PFU detection rate vs. the decision threshold at 9 h, 12 h and 15 h detection time points, where the error bars show the standard deviation across 5 test plates. FIG. 9C shows averaged false discovery rate detected at 20 hours of incubation vs. the decision threshold, where the error bars show the standard deviation across 5 test plates (the standard deviations for the threshold of 0.5, 0.7, and 0.9 are all zero).

FIGS. 10A-10D illustrate visual and statistical comparisons between the BioTek-based automatic PFU counting method and the method disclosed herein. FIG. 10A is a table showing the total number of the over-counted, false positive, and false negative PFUs summarized across 5 test plates for both the BioTek-based method and the method employed by the device 10. FIG. 10B shows the visual detection results of the BioTek-based method, where it exhibits cases of good PFU detection, over-segmentation of large PFUs, false positives, false negatives caused by missing late-growing PFUs, and under-detection of the overlapping PFUs in the dense samples. FIG. 10C shows the stained ground truth of the traditional viral plaque assay after 48 hours of incubation. FIG. 10D shows the corresponding PFU probability maps and the visualized final detection results at 20 hours of incubation using the disclosed method, where the dots label the centers of the PFUs detected/counted by the device and n represents the number of the counted PFU.

FIGS. 11A-11B illustrate the generalization of the stain-free viral plaque assay and its PFU detection neural network to 12-well plates. FIG. 11A shows whole plate comparison of the stain-free viral plaque assay after 20 hours of incubation (VSV) against the traditional plaque assay after 48-h incubation and staining. FIG. 11B illustrates the averaged detection rate using the label-free viral plaque assay device. The error bars show the standard deviation across 5 positive test wells (from a 12-well plate).

FIGS. 12A-12B illustrate the performance of the stain-free plaque assay for HSV-1 samples. FIG. 12A illustrates whole well comparison of the stain-free viral plaque assay after 48 h, 56 h, 64 h, and 72 h of incubation against the traditional plaque assay after 120 hours of incubation and standard staining. FIG. 12B shows the averaged HSV-1 detection rate using the label-free viral plaque assay. The error bars show the standard deviation across 10 positive test wells.

FIGS. 13A-13C illustrate the performance of the stain-free plaque assay for EMCV samples. FIG. 13A is a whole well comparison of the stain-free viral plaque assay after 40 h, 45 h, 50 h, and 55 h of incubation against the traditional plaque assay after 72 hours of incubation and standard staining. FIG. 13B illustrates averaged EMCV detection rate using the label-free viral plaque assay. The error bars show the standard deviation across 10 positive test wells. FIG. 13C illustrates zoomed-in detection results of the plaque merging regions from 3 other EMCV wells (different from the well shown in (FIG. 13A)) at 40 hours, 43 hours, 46 hours, 49 hours, 52 hours, and 55 hours using the stain-free viral plaque assay, with a comparison of the same regions from the traditional plaque assay after 72 hours of incubation and staining. The stain-free method reveals the individual PFUs inside these plaque-merging regions due to its early detection capability.

FIGS. 14A-14F illustrate the phase distributions for virus-infected PFU regions vs. non-PFU (negative) regions. FIG. 14A is an example field-of-view (FOV) of the holographic phase image after the free-space backpropagation of a positive well containing 3 PFUs. FIG. 14B shows matching FOV to FIG. 14A after contrast enhancement to better visualize the PFUs. FIG. 14c shows zoomed in time-lapse holographic phase images from 12 h to 15 h for the 3 positive PFUs. FIG. 14D shows phase distribution histogram of 128 positive FOVs, each with 500×500 pixels. FIG. 14E illustrates time-lapse holographic phase images from 12 h to 15 h for 3 non-PFU regions. FIG. 14F illustrates the phase distribution histogram of 128 non-PFU (negative) FOVs, each with 500×500 pixels.

FIG. 15 illustrates the analysis of the defocusing tolerance of the device at 12 hours, 15 hours, and 18 hours of incubation for VSV. For the curves at each time point, the line marked #1 refers to the number of missing PFUs in the final detection results of the digitally defocused images at different propagation distances (|Δz|>0) and the focused images (Δz=0) compared to the 48-hour-stained ground truth. The line #2 refers to the number of false positives in the final detection results of the digitally defocused images at different propagating distances (|Δz|>0) and the focused images (Δz=0) compared to the 48-hour-stained ground truth. The axial defocusing distance that can be tolerated by the device 10 without changing the PFU detection results (i.e., the shaded zone) is 1000 μm (−400 μm˜600 μm), 1200 μm (−400 μm-800 μm), and 1600 μm (−600 μm-1000 μm) for 12 hours, 15 hours, and 18 hours of incubation time, respectively. Visualized examples of the PFU detection results at different defocus distances (|Δz|>0) and focused images (Δz=0) compared to the 48-hour-stained ground truth are shown underneath the curves at each time point.

FIGS. 16A-16B illustrate a comparison of the VSV samples stained after being imaged by the device and from the control experiments (by turning off the imaging set-up). FIG. 16A illustrates a table showing the number of VSV PFUs and PFU size comparison between 3 plates stained after being imaged by the device and 3 control plates. FIG. 16B shows examples of VSV PFU regions from plates stained after being imaged by the device and from control plates. The VSV samples after being imaged by the device mean that they were imaged by the imaging set-up for 20 hours and then further incubated till 48 hours, while the control samples mean that they were incubated for 48 hours without the imaging set-up turned on.

FIGS. 17A-17H illustrate the workflow of the coarse PFU localization algorithm, which is only used during the training phase for efficient data curation. A coarse PFU localization mask (binary) can be obtained using the PFU localization algorithm following the steps from (FIG. 17A) to (FIG. 17F).

FIG. 18 illustrates the network architecture of the PFU decision neural network. This network is based on the DenseNet structure, with the 2D convolutional layers replaced by the pseudo-3D building blocks.

FIG. 19 illustrates loss, sensitivity, and specificity curves of the PFU decision neural network training process.

FIG. 20 illustrates the effect of the maximum projection method. The impact of using the maximum projection method to avoid lower PFU probability values being generated from the center of the late-stage PFUs (see e.g., the central regions of the red circled areas). Also see the Methods section of the main text.

### DETAILED DESCRIPTION OF ILLUSTRATED EMBODIMENTS

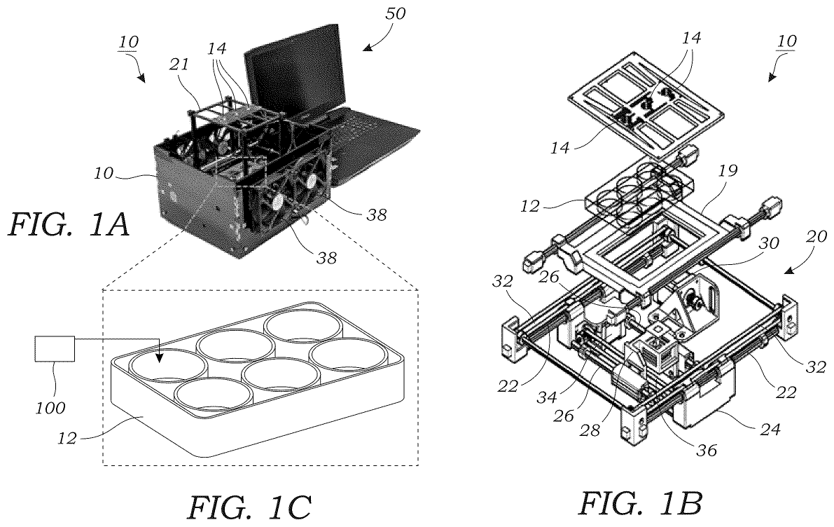

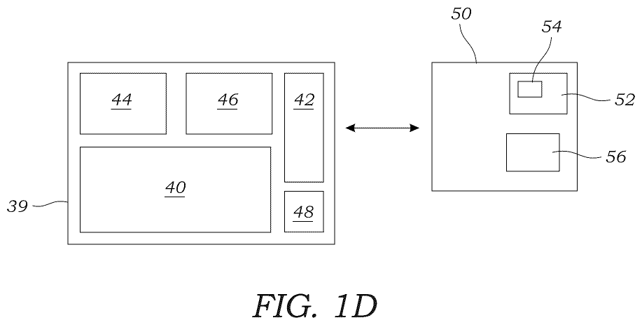

With reference to FIGS. 1A-1C, the device 10 for performing an automated viral plaque assay of a sample 100 includes a sample holder 12 having, in one embodiment, one or more wells or sample-holding regions formed therein and configured to incubate the sample 100 (which may contain virus) with a layer of cells in the sample holder 12. As explained herein, a 6-well and 12-well plates were primarily used as the sample holder 12 to hold the sample 100 and cells although other sample holders are contemplated. The sample holder 12 contains cells seeded in a layer on the bottom surface of the sample holder 12. The layer of cells along with sample that is exposed to the cells is covered in an agarose layer that also coats the bottom surface of the sample holder 12. The sample holder 12 is optically transparent to allow the passage of light (light is also able to transmit through the agarose layer). The sample 100 may include any types of samples including, for example, a biological sample, environmental sample, or food sample. The sample 100 may be processed or unprocessed.

The device 10 includes one or more illumination sources 14 that are disposed on one side of the sample holder 12 (e.g., top) and is configured to illuminate the sample holder 12 containing the cells and the sample 100. In the experimental setup described herein, the illumination sources 14 include three (3) laser diodes although LEDs may also be used. These could be the same color/wavelength(s) (as described) or they could be different colors or emit light at different wavelengths or wavelength ranges. This would allow imaging to take place at multiple, different wavelengths, for example. The one or more illumination sources 14 may be sequentially illuminated so that different areas of the sample holder 12 are illuminated at a given time.

The device 10 includes one or more image sensors 16 disposed on an opposing side of the sample holder 12 (e.g., bottom) and configured to capture holographic images of plaques that form in the one or more wells or sample-holding regions of the sample holder 12 over a plurality of incubation times. More specifically, the one or more image sensors 16 capture images of evolving viral plaque in the one or more wells or sample-holding regions of the sample holder 12. With reference to FIGS. 1A and 1B, the device 10 includes a housing 18 that contains a sample holder tray 19 that accommodates or holds the sample holder 12 during the assay, the one or more illumination sources 14, and the one or more image sensors 16. A frame 21 (FIG. 1A) holds the illumination sources 14 at a fixed distance above the sample holder tray 19 which receives the sample holder 12 (e.g., a several centimeters to tens of centimeters above the sample holder 12). In the experimental embodiment, three green laser diodes emitting light at 515 nm were used as the illumination sources 14. These were sequentially driven to illuminate different areas of the sample holder 12. The device 10 may be located withing an incubator (not shown) to allow for controlled growth conditions.

The one or more image sensors 16 (e.g., CMOS image sensor) are held within a two-dimensional (2D) scanning stage 20 best seen in FIG. 1B. The 2D scanning stage 20 includes a pair of linear translation rails 22 are coupled to an image sensor assembly 24 that includes pair of linear bearing rods 26 that contain a moveable mount 28 secured to moveable bearings on the rods 26 that contains or holds the one or more image sensors 16. A first stepper motor 30 is used to drive a pair of belts 32 that move the image sensor assembly 24 in a first direction via the pair of linear translation rails 22. The image sensor assembly 24 includes a second stepper motor 34 that interfaces with a belt 36 that is connected to the moveable mount 28. Actuation of the second stepper motor 34 thus drives the mount 28 along the pair of linear bearing rods 26. The 2D scanning stage 20 is thus able to move the one or more image sensors 16 in orthogonal directions (e.g., x, y directions) to scan the surface of the sample holder 12. The distance between the bottom surface of the sample holder 12 and the one or more image sensors 16 is typically within a few mm (e.g., ˜5 mm).

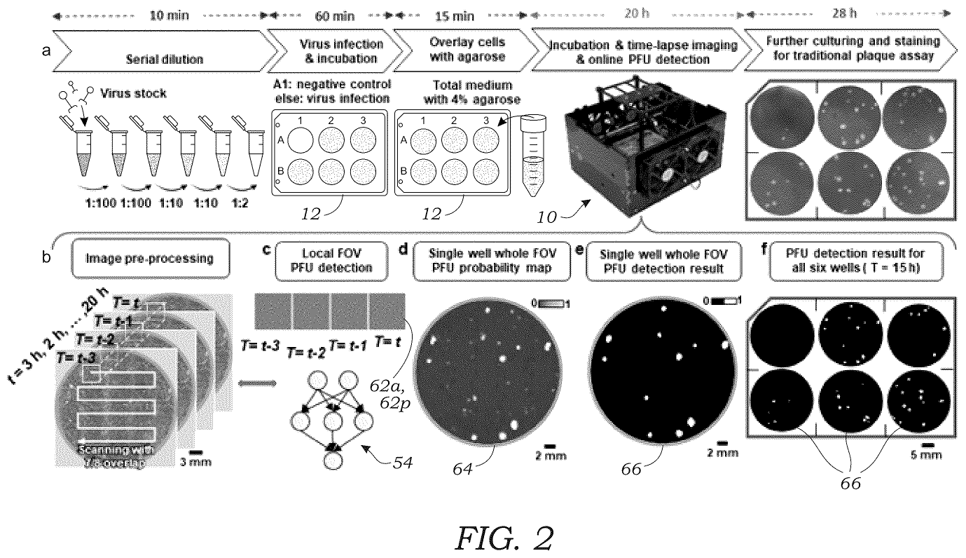

As seen in FIG. 1B, the 2D scanning stage 20 is used to scan the one or more image sensors 16 in a plane (e.g., raster scanning as seen in FIG. 2) so that the entire well or sample-holding region of the sample holder 12 (or multiple such wells or regions) can be imaged. In some embodiments, there may be multiple image sensors 16 that can image in parallel. As seen in FIG. 1A, the housing 18 was partially open to the external environment which allowed access to load or remove the sample holder 12 in the sample holder tray 19. One or more fans 38 may be provided in the housing 18 which direct air over the sample 100 mitigate heat generated by the one or more image sensors 16. While a belt-driven 2D scanning stage 20 is illustrated herein, it should be appreciated that other 2D scanning methods may also be used (e.g., screw drive, servo drive, and the like).

With reference to FIG. 1D, the device 10 includes a microcontroller 40, which may be contained in the housing 18 on a printed circuit board (PCB) 39, and is used to offload images acquired using the one or more image sensors 16 to a separate computing device 50 as well as control the various operations of the device 10. For example, the microcontroller 40 may control the operation of the one or more illumination sources 14 through an illumination driver chip or circuitry 42 coupled thereto. The microcontroller 40 also controls the motion of the 2D scanning stage 20 through control of the first stepper motor 30 and second stepper motor 34 via respective driver chips 44, 46. The microcontroller 40 also can turn the one or more image sensors 16 on or off through a field-effect transistor-based switch 48. The microcontroller 40 may be programmed to carry out pre-defined raster scanning of the sample holder 12 my controlled scanning of the one or more image sensors 16. This may be done using an automatic control program in the separate computing device 50. The microcontroller 40, illumination driver chip 42, motor driver chips 44, 46 and FET switch 48 may be located on a printed circuit board (PCB) 39 that is mounted within the housing 18. A power supply (not shown) connected to a wall plug provides a source of power to the electronics of the device 10.

With reference to FIG. 1D, the device 10 further includes a computing device 50 that contains an automatic control program 56 that controls the sequence and timing of operations of microcontroller 40. The computing device 50 also executes image processing software 52. With reference to FIG. 2, the image processing software 52 is configured to reconstruct the raw holographic images 60 of the smaller, localized field of views (FOV) captured by the one or more image sensors 16 into phase images 62p and/or amplitude images 62a. This may include reconstruction of phase 62p images using, for example, the well-known angular spectrum approach based back-propagation. The localized phase image 62p FOVs used herein had a size of 480 pixels×480 pixels. During the raster scanning process, these localized phase image 62p FOVs are overlapping to a certain degree. For a single well of the sample holder 12, this results in ˜400×400 localized phase image 62p FOVs.

As explained below, in one embodiment, these reconstructed images 62a. 62p of localized FOVs of the sample holder 12 obtained over different incubation times are then input to a trained neural network 54 executed by the image processing software 52 that generates a PFU probability for the localized FOVs. These localized PFU probabilities can then be digitally stitched into a whole field-of-view (FOV) PFU probability map 64 that covers the wells or sample-holding regions of the sample holder 12. A threshold may then be applied to the whole FOV PFU probability map 64 to generate the output PFU image 66 identifying the PFUs and/or virus-infected areas for the one or more wells or sample-holding regions of the sample holder 12. For example, as explained herein, a probability threshold of 0.5 was used, although other thresholds may be used.

In another embodiment, rather than input the reconstructed images 62a, 62p of localized FOVs to the trained neural network 54, these reconstructed images 62a, 62p of localized FOVs can first be digitally stitched together as described herein to create a reconstructed whole FOV image. These could be reconstructed phase images 62p and/or reconstructed amplitude images 62a. These whole FOV images obtained over different incubation times are then input to the trained neural network 54 to generate a PFU probability map 64 of whole field of view. This PFU probability map 64 of the whole FOV may then be subject to a thresholding operation as described above to generate the final output PFU image 66 identifying plaque-forming units (PFUs) and/or virus-infected areas for the one or more wells or sample-holding regions of the sample holder 12.

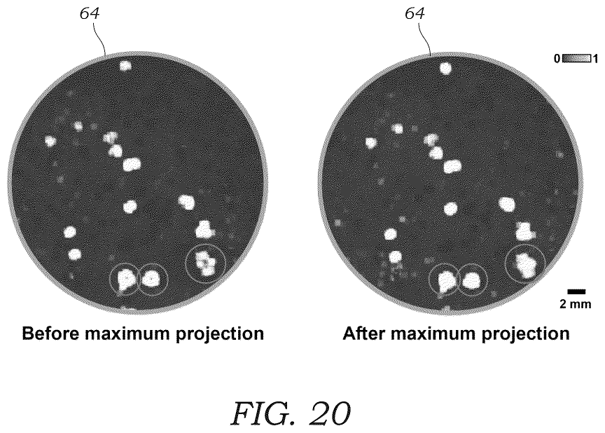

In addition, as explained herein, image post-processing may be used in any of these embodiments to generate the final output PFU image 66 identifying PFU and/or virus-infected areas detection areas. This includes two image post-processing steps including: 1) maximum probability projection along time (illustrated in FIG. 20), and 2) PFU (and/or virus-infected areas) size thresholding. The maximum projection was used to compensate for the lower PFU probability values generated from the center region of the PFU (and/or virus-infected areas) when it enters the late stage of its growth. This artifact is corrected is by using the maximum probability projection as explained herein.

The image processing software 52 may automatically calculate the number of PFUs and/or virus-infected areas in each of the one or more wells or sample-holding regions of the sample holder 12. The image processing software 52 may also automatically quantify the size of PFUs and/or virus-infected areas in each of the one or more wells or sample-holding regions of the sample holder 12. The image processing software 52 may also output a virus concentration of the sample 100 by using a quantitative relationship between the incubated virus concentration and the virus-infected area on the cell monolayer.

As explained herein, a single image sensor 16 was moved relative to a stationary sample holder 12. However, it should be appreciated that the one or more image sensors 16 may be stationary and the sample holder 12/sample holder tray 19 may be moveable. In yet another alternative, both the one or more image sensors 16 and the sample holder 12/sample holder tray 19 are moveable relative to one another.

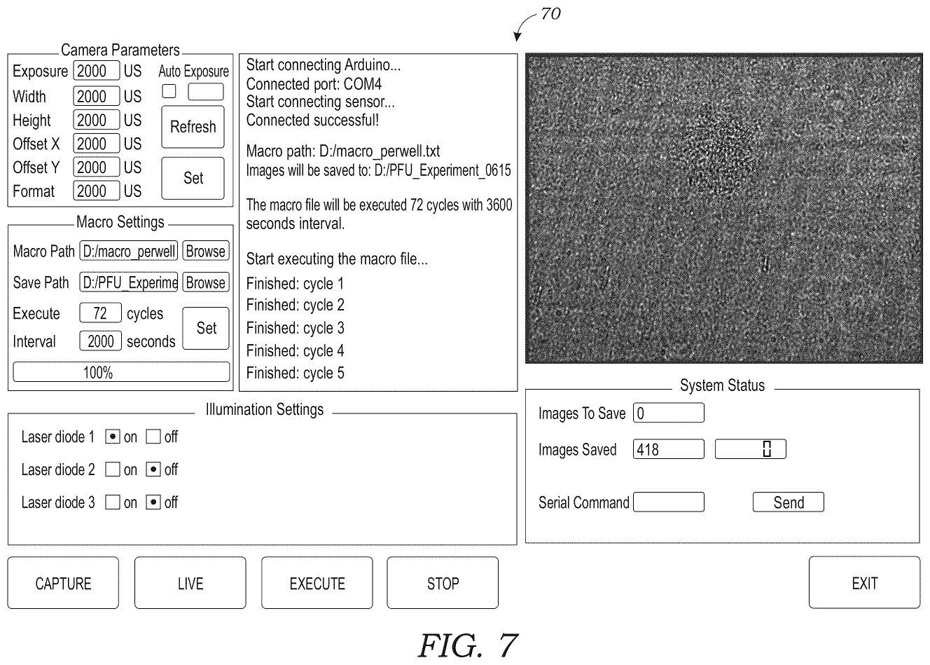

A graphical user interface (GUI) 70 such as that illustrated in FIG. 7 may be used with the computing device 50 to adjust the image capture parameters (e.g., exposure time etc.) of the one or more image sensors 16 and communicate with the microcontroller 40 to further switch the one or more illumination sources 14 or image sensor(s) 16 on/off and control the movement of the 2D scanning stage 20. The GUI 70 may also be used to execute or initiate the automatic control program 56. The GUI 70 may also be used to display the final output PFU image 66 identifying PFUs and/or virus-infected areas, the size/area(s) of the PFUs, the count of the PFUs, and/or the concentration of the virus in the sample 100.

### Experimental

### Results

To demonstrate the efficacy of the device 10, fourteen (14) plaque assays were prepared using the Vero E6 cells and VSV. The sample preparation steps followed standard plaque assays and are summarized in FIG. 2A (described in detail in Methods section). For each 6 well-plate, ˜6.5×10⁵ cells were seeded to each well, which was then incubated inside an incubator (Heracell VIOS 160i CO2 Incubator, Thermo Scientific) for 24 hours to achieve a cell monolayer with ≥95% coverage. During the virus infection, 5 wells were infected by the VSV100 μL of the diluted VSV suspension (obtained by diluting a 6.6×108 PFU/mL VSV stock with a dilution factor of 2-1×10⁻⁶), and 1 well was left for negative control. Then, 2.5 mL of the overlay solution containing the total medium with 4% agarose was added to each well (see the Methods section for details). After the solidification of the overlay at room temperature, each sample 100 was first placed into the imaging set-up for 20 hours of incubation, performing time-lapse imaging to capture the spatiotemporal information of the sample 100. Then, the same sample 100 was left in the incubator for an additional 28 hours to let the PFUs grow to their optimal size for the traditional plaque assay (this is only used for comparison purposes). Finally, each sample 100 was stained using crystal violet solution to serve as the ground truth to compare against the label-free method.

To train and test the network-based PFU classifier 54, fifty-four (54) wells (i.e., 45 positive wells and 9 negative wells) were used for training and thirty (30) wells (i.e., 25 positive wells and 5 negative wells) were used for testing. During the training phase, a machine learning-based coarse PFU localization algorithm was developed to both accelerate the training dataset generation and delineate the potential false positives (see the Method sections for details). After this PFU localization algorithm screened each sample 100, the resulting PFU candidates were further examined manually for confirmation using a custom-developed Graphical User Interface built for training. This manual examination was only used during the training phase prepare the training data to correctly and efficiently. The negative training dataset was populated purely from the negative control well of each well plate. In total, 357 true positive PFU holographic videos and 1169 negative holographic videos were collected for training the PFU decision neural network. This dataset was further augmented to create a total of 2594 positive and 3028 negative holographic videos (see the Method sections), where each frame had 480×480 pixels, and the time interval between two consecutive holographic frames was 1 hour.

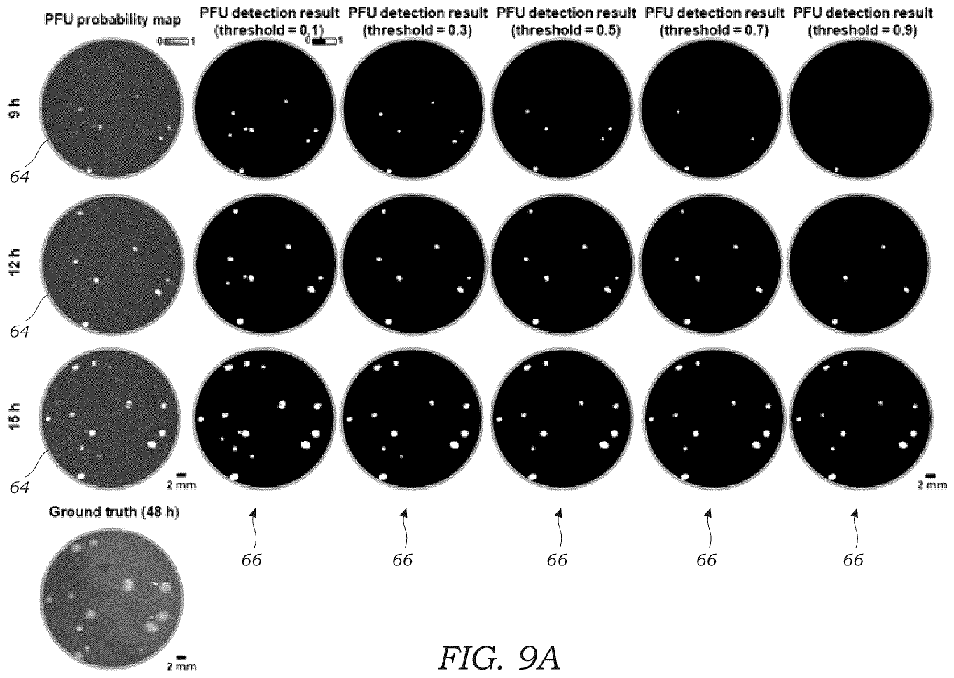

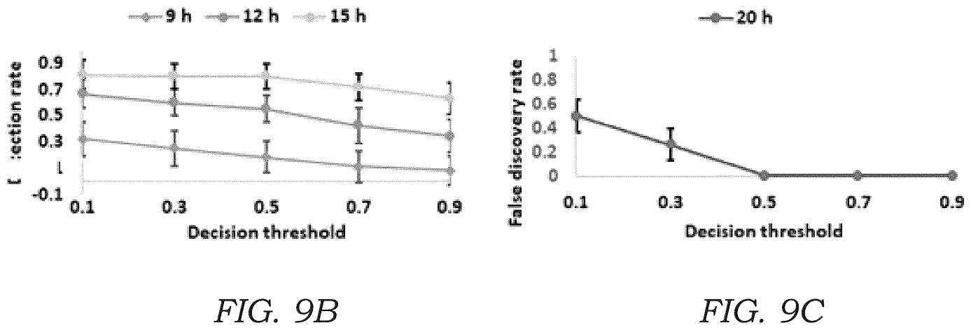

After the neural network-based PFU classifier 54 was trained, it was blindly tested on all thirty (30) test wells in a scanning manner (operation b in FIG. 2) without the need for the PFU localization algorithm, which was only used for the training data generation. For each test well, there are ˜18000×18000 effective pixels (representing a 30-30 mm² active area after discarding the edges); the digital processing of each test well using the PFU classifier network 54 takes ˜7.5 min, which automatically converts the holographic phase images 62p of the well into a PFU probability map 64 (operation d of FIG. 2). Each pixel of the well on this map indicates the statistical probability of the local area (0.8×0.8 mm²) centered at this pixel having a PFU. Using a probability threshold of 0.5 (i.e., retaining those local FOVs that have a threshold of 0.5 or above), the final PFU output PFU image 66 was generated and the quantification result was obtained across the entire test well area (see e.g., operations e-f in FIG. 2). The impact of this probability threshold is analyzed and discussed in the section titled “Analysis of the effect of the decision threshold on the PFU detection results” herein and along with reference to FIGS. 9A-9C, which illustrates the trade-off between the specificity and the sensitivity by selecting different threshold values.

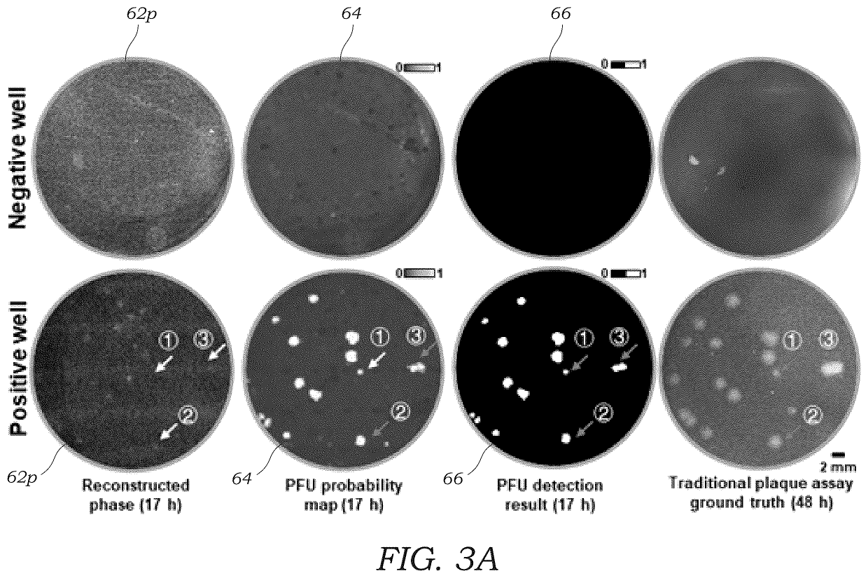

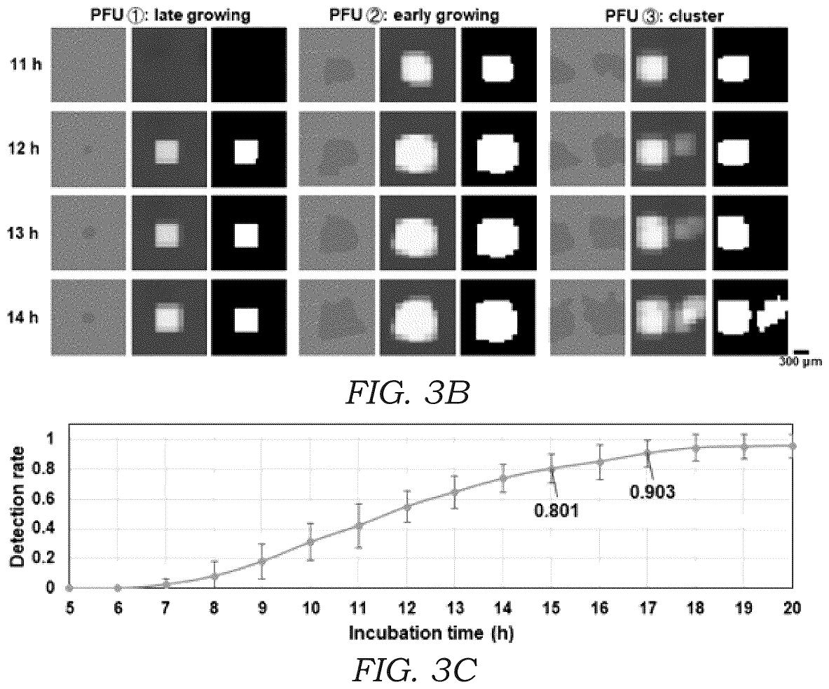

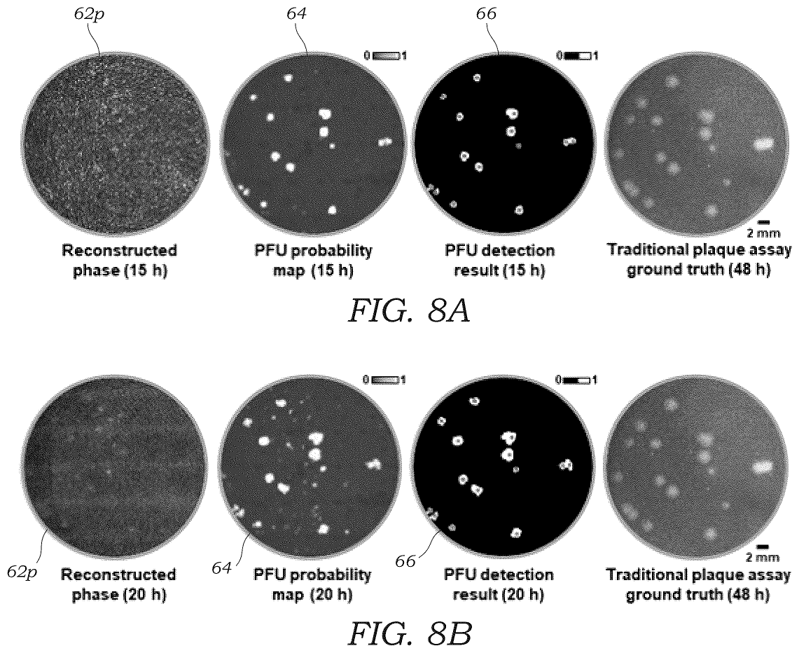

FIG. 3A shows examples of the performance of the device 10 in detecting VSV PFUs after fifteen (15) hours of incubation. FIGS. 8A and 8B also shows the detection results after 15 hours and 20 hours of incubation, reported for comparison. Three representative PFUs are also selected and shown in FIG. 3B. When a PFU is in its early stage of growth, with its size much smaller than the 0.8×0.8 mm² virtual scanning window, it appears as a square (shown by the PFU\textcircled{1} in FIG. 3B) in the final detection result, which effectively is the 2D spatial convolution of the small scale PFU with the scanning window. As another example, PFU\textcircled{3} shows a cluster forming event where the two neighboring PFUs can be easily differentiated using the method as opposed to the traditional plaque assay where they physically merged into one. FIG. 3C further shows the PFU quantification achieved by the device 10 compared to the 48-hour traditional plaque assay results. A detection rate of ≥90° at 20 hours of incubation was achieved without having any false positives at any time point despite using no staining.

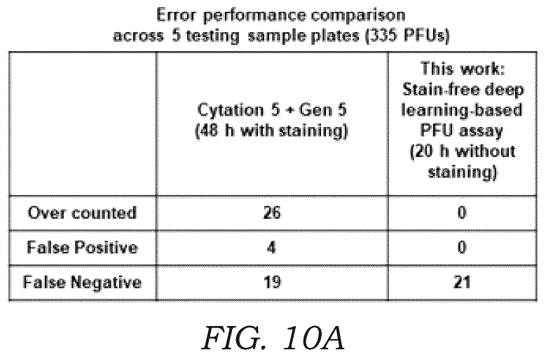

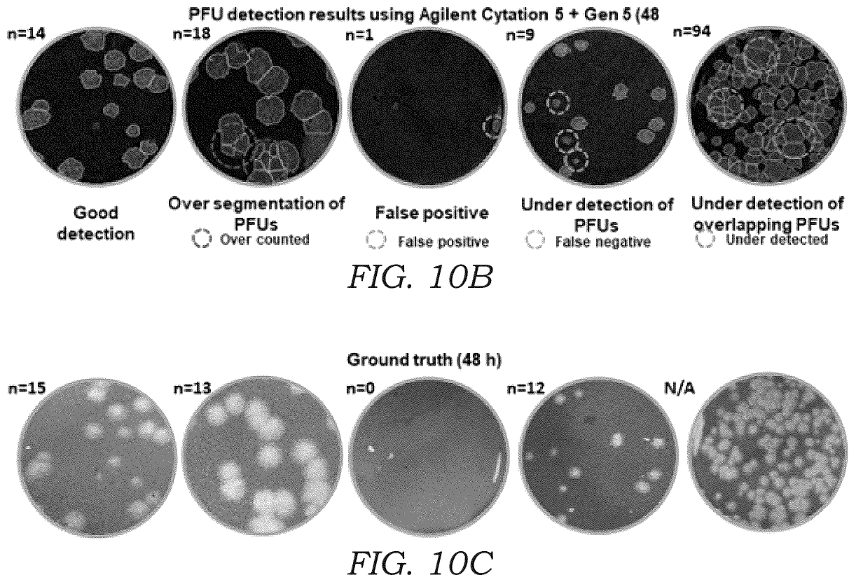

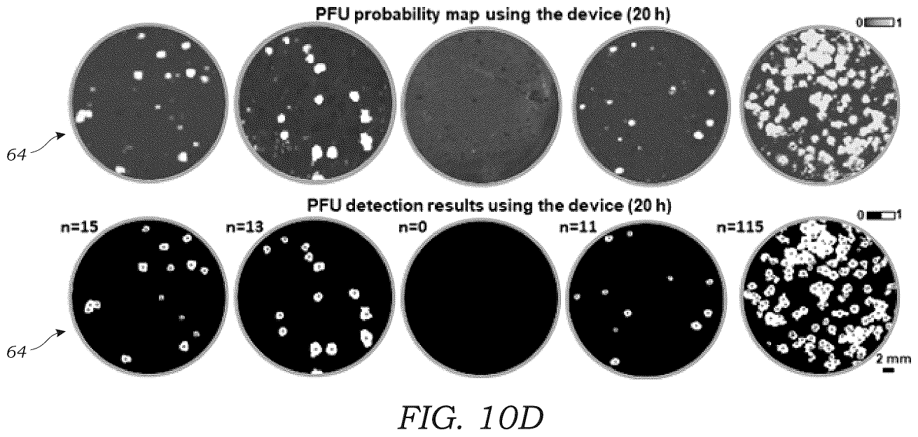

The results were also compared against a widely-adopted automatic PFU counting system that is commercially available. After the 48-hour incubation, followed by the standard staining protocol, the same five 6-well test plates were imaged (VSV) using this time the Agilent BioTek Cytation 5 device (Agilent Technologies, Santa Clara, CA). After the automated image acquisition with this system, PFU detection was performed by Gen 5 software (Agilent Technologies, Santa Clara, CA) using the optimized settings of its automated PFU counting algorithm (see the Methods section). A detection rate of 94.3% was achieved with a 1.2% false discovery rate. In comparison, the presented stain-free holographic method and device 10 achieved a PFU detection rate of 93.7% with 0% false discovery rate at 20 hours of incubation for the same samples (i.e., 28 hours earlier compared to the standard incubation time). In addition to missing some of the late-growing PFUs and introducing some false positives, this commercially available automated PFU counting system also showed over-segmentation on large PFUs and under-detection of PFUs for samples with high virus concentrations. A detailed report of the over-counted, false negative, and false positive PFUs, as well as a visualized PFU detection performance summary of this standard detection method compared to the device 10 are demonstrated in FIGS. 10A-10D.

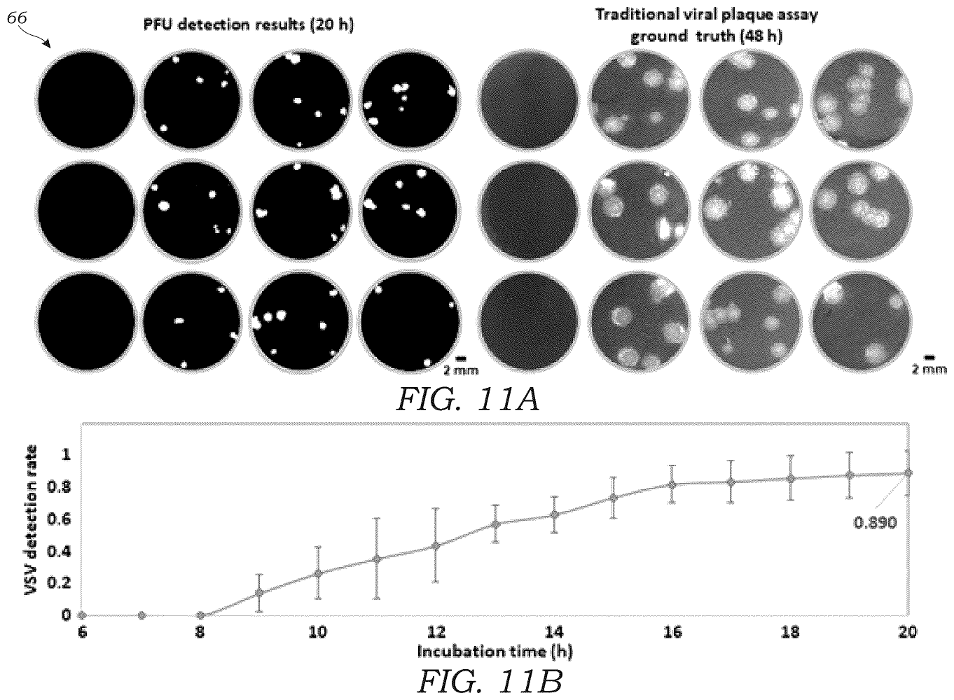

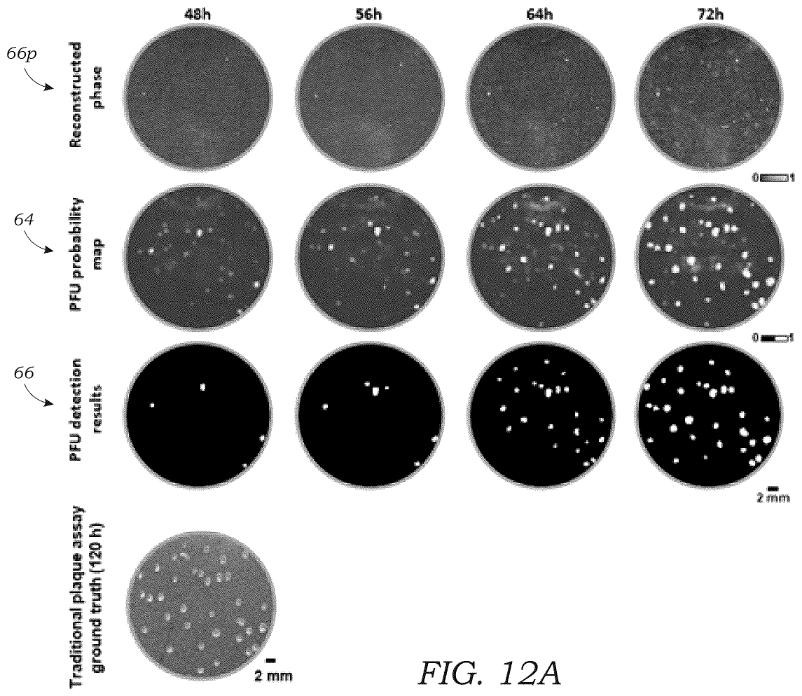

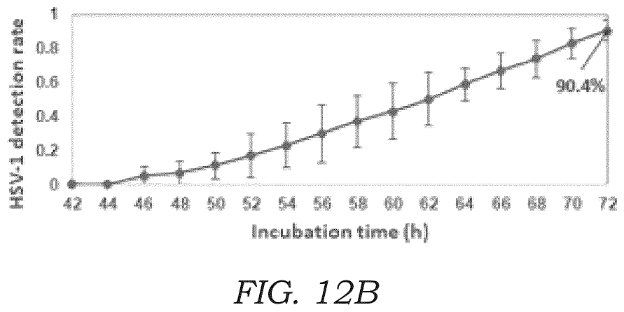

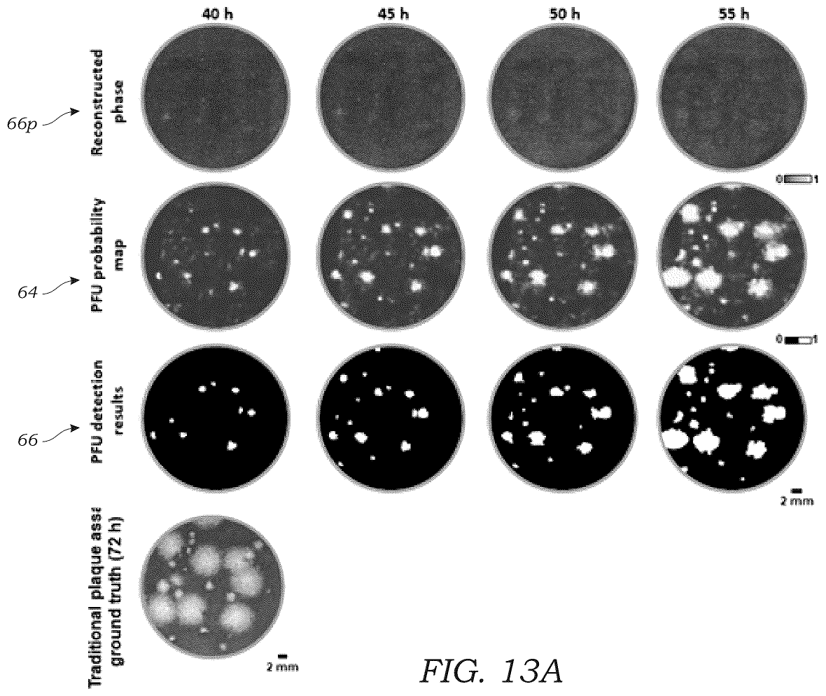

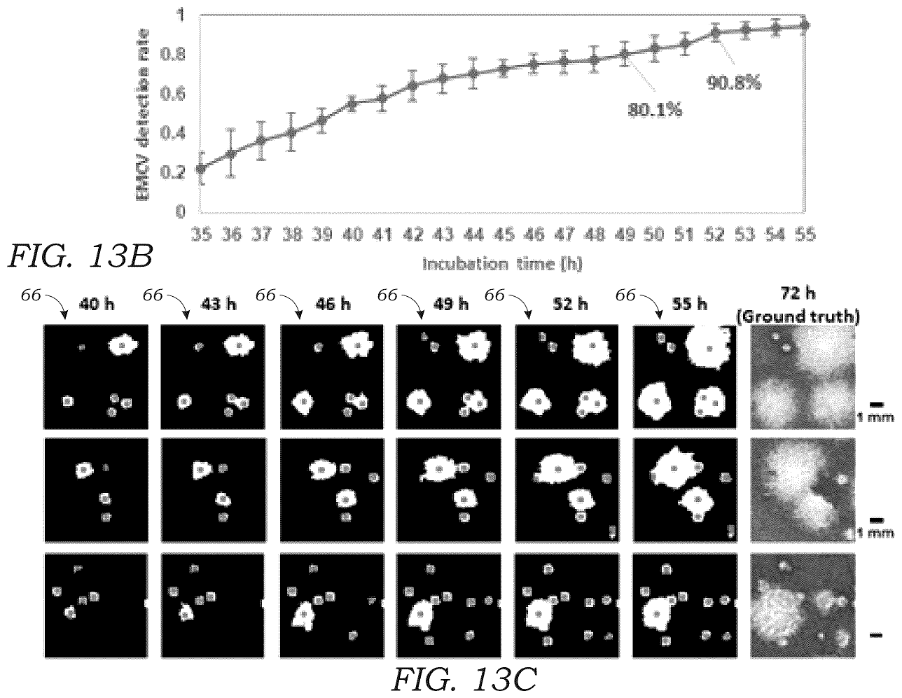

In addition to saving incubation time and being stain-free, the device 10 also exhibits strong generalization capability. For example, after its training with 6-well plates, it can be directly used on 12-well plates without the need for any modifications or retraining steps (see e.g., “Well plate preparation” in the Methods section). Without any transfer learning steps, a PFU detection rate of 89% was achieved at 20 hours of incubation (VSV) when blindly tested on a 12-well plate (see FIGS. 11A-11B). Furthermore, the computational PFU detection device 10 can generalize to detect other types of viruses (e.g., HSV-1 and EMCV) through transfer learning while using the VSV PFU detection network 54 as the base model. For HSV-1, two 6-well plates were prepared for transfer learning (see the Methods section), imaged for 72 hours with a 2-hour imaging interval/period, and further incubated for a total of 120 hours to obtain the stained ground truth PFU samples. The collected data were used to populate the training dataset for transfer learning. The resulting HSV-1 neural network 54 was blindly tested on 12 additional HSV-1 test wells (containing in total 214 HSV-1 PFUs and 2 negative control wells); as shown in FIGS. 12A-12B, without introducing false positives, the device 10 achieved 90.4% detection rate at 72 hours, reducing 48 hours of incubation time compared with the 120 hours required by the traditional HSV-1 plaque assay. Similarly, for EMCV three 6-well plates were used for transfer learning (see the “Well plate preparation” subsection of the Methods), which were imaged for 60 hours with an imaging interval of 1 hour and stained at 72 hours of total incubation, following the standard protocols. When tested on 12 additional EMCV test wells (containing in total 249 EMCV PFUs and 2 negative control wells), a detection rate of 90.8% with 0% false positives was obtained at 52 hours of incubation, as shown in FIGS. 13A-13C, achieving 20 hours of incubation time saving compared with the ground truth of 72 hours for the traditional EMCV plaque assay. Notably, the EMCV plates contain much more late-growing PFUs compared to VSV or HSV-1, which is also in line with earlier observations. The device 10 achieved a reliable EMCV plaque counting performance even for the PFU merging regions of a test well, as illustrated in FIG. 13C. Due to the spatiotemporal feature analysis-based early detection capability of the device 10, it could identify each individual PFU within these merging PFU regions at the early phases of the plaque growth, eliminating false negatives or misses that might have arisen in standard PFU counting methods due to the expansion of earlier PFUs, spatially covering (and obscuring) the late-growing plaques.

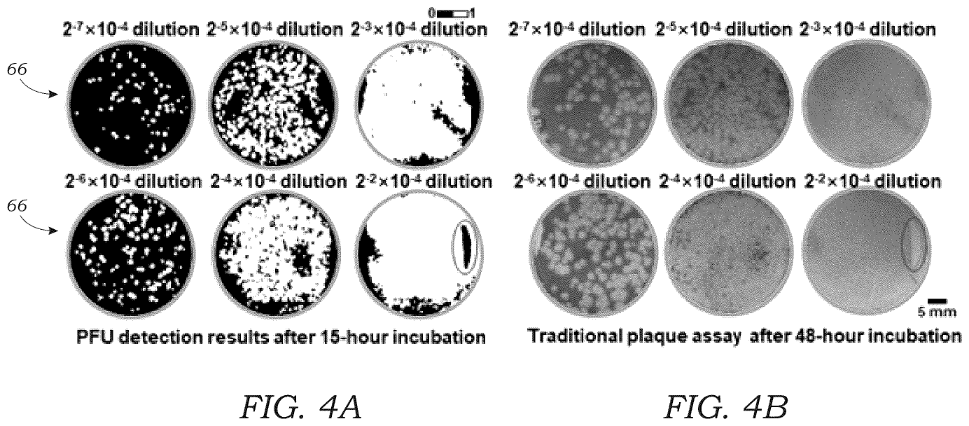

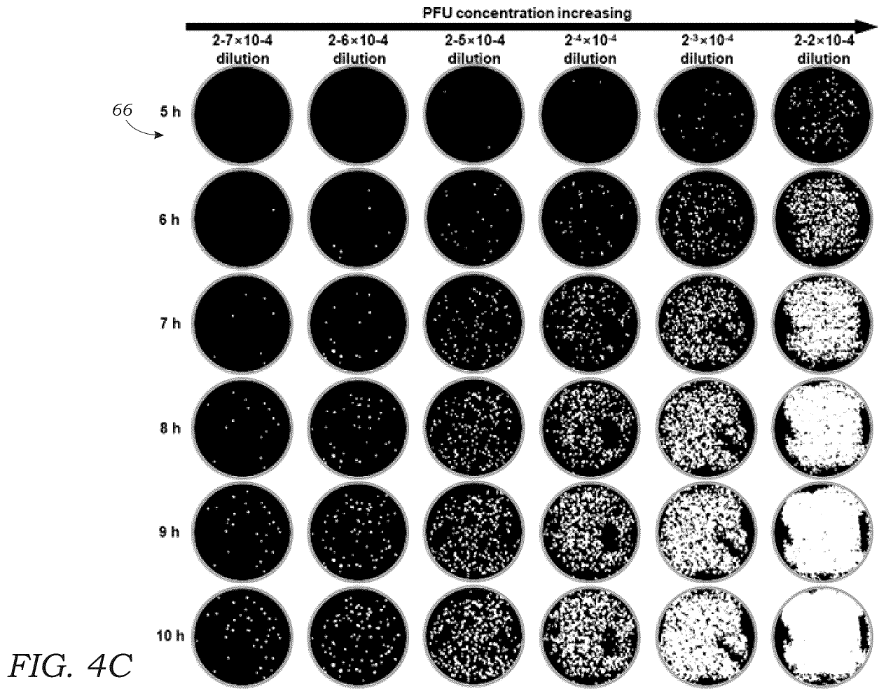

The device 10 is cost-effective, compact, and automated, and can also handle a larger virus concentration range with a more reliable PFU readout. To demonstrate this, another five (5) titer test plates were prepared, where for each plate, all six (6) wells were infected by VSV, but with a 2 times dilution difference between each well, covering a large dynamic range in virus concentration from one test well to another. As shown in FIGS. 4A-4C, the method is effective even for the higher virus concentration cases; see, for example, the dilution cases of 2⁻²10⁻⁴ and 2⁻³×10⁻⁴. In the traditional 48-hour plaque assay, only the lowest virus concentration is suitable for the PFU quantification due to severe spatial overlapping, whereas for the label-free device 10, this can automatically and accurately count the individual PFUs at an early stage, even for the highest virus concentration (see FIG. 4C).

Furthermore, the method provides a more reliable readout; for example, in the circled region in FIGS. 4A-4B, the absence of the cells was caused by some random cell viability problems that occurred during the plaque assay. In the device 10, these artifacts can be easily differentiated from the cell lysing events caused by the viral replication, since the spatiotemporal patterns for these two events are vastly different (assessed by the trained PFU probability network 54). This makes the deep learning-enabled device 10 resilient to potential artifacts or cell viability issues randomly introduced during the sample preparation steps.

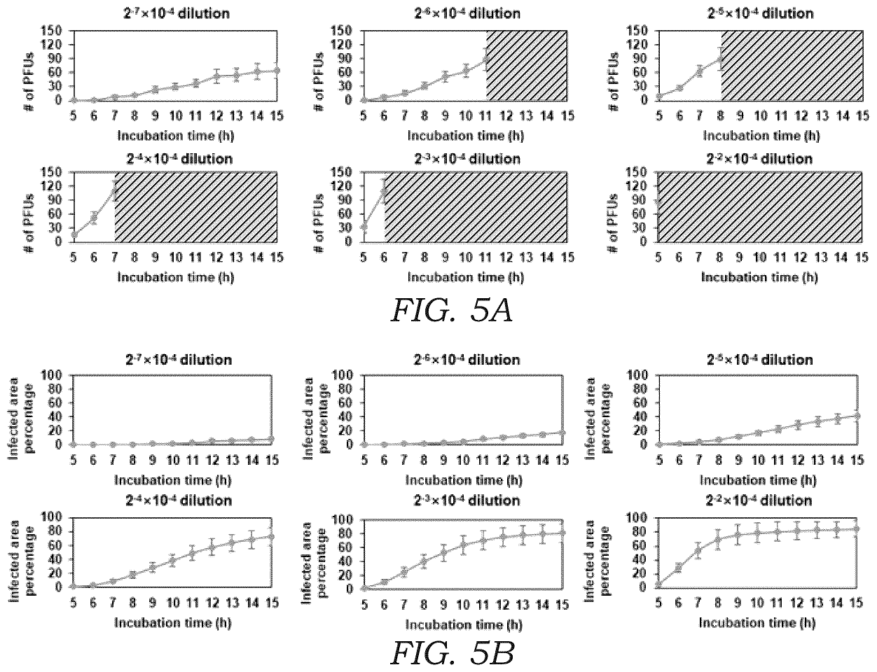

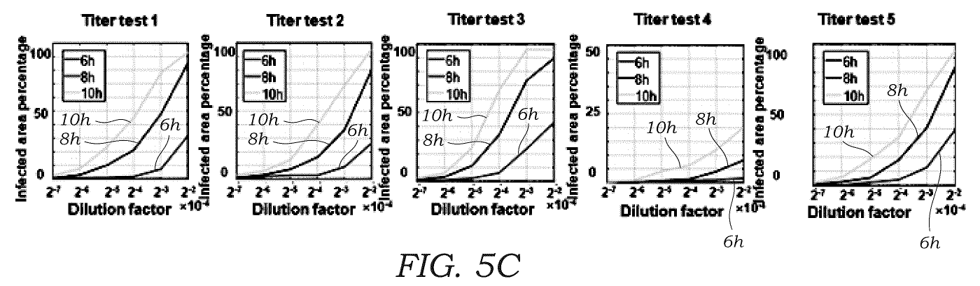

Due to the high virus concentration used in the five (5) titer test samples. PFUs quickly clustered and were no longer suitable for manual counting, as shown in FIG. 5A. However, the quantitative readout and the PFU probability map 64 of the device 10 allows one to obtain the area of the virus-infected regions across all the time points during the incubation period, as shown in FIG. 5B. To better illustrate this, FIG. 5C plots the virus dilution factor vs. the ratio of the infected cell area per test well (in %) for all the samples 100 at 6, 8, and 10 h of incubation time. Despite the existence of some serial dilution errors, late virus wakeups, and PFU clustering events, the infected area percentage that the device 10 measured is monotonically decreasing with the increasing dilution factor for all the incubation times. This suggests that, by calibrating the system, the virus concentration (PFU % mL) can also be estimated from the percentage of the infected cell area per well.

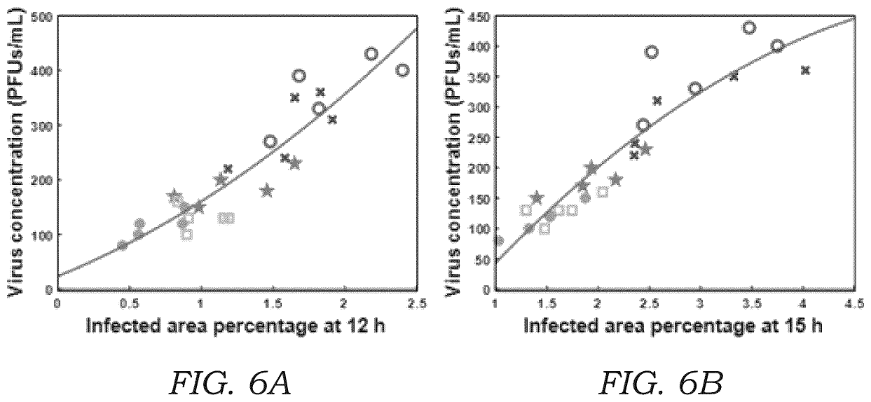

Furthermore, using the area percentage of the virus-infected region as a label-free quantification metric, the device 10 and method can provide earlier PFU readouts. To show this, the infected area percentage was computed for all the twenty-five (25) positive/infected wells of the blind testing plates used to generate FIG. 3C. As shown in FIGS. 6A, 6B, when the infected area percentage is sufficiently large (>1%), a faster PFU concentration readout can be provided at 12-h or 15-h. Since the size of an average PFU on the well is physically larger at 15 hours of incubation compared to 12 hours, the slope of the solid calibration curve in FIG. 6B is smaller than FIG. 6A, as expected. For samples with even higher virus concentrations, the infected cell area percentage could reach >1% in ≤10 hours of incubation (shown in FIG. 5C), providing the PFU concentration readout even earlier.

A cost-effective and automated early PFU detection device 10 is disclosed that uses a lens-free holographic imaging system and deep learning. This deep learning-based stain-free device captures time-lapse phase images 62p of a test well at a throughput of ˜0.32 Giga-pixels per scan, which is then processed by a PFU quantification neural network 54 in ˜7.5 min to yield the PFU distribution of each test well. The high detection rate of this label-free device 10 with 100% specificity shown in FIG. 3C is a conservative estimate since the ground truth data were obtained after 48-h of incubation. In the early stages of the incubation period, many VSV PFUs did not even exist physically, which led to under-detection (e.g., a detection rate of 80.1% and 90.3% at 15 and 17 hours of incubation, respectively). This means that if one were to use the existing PFUs as the ground truth for the quantification at each time point, the detection rate would be even higher.

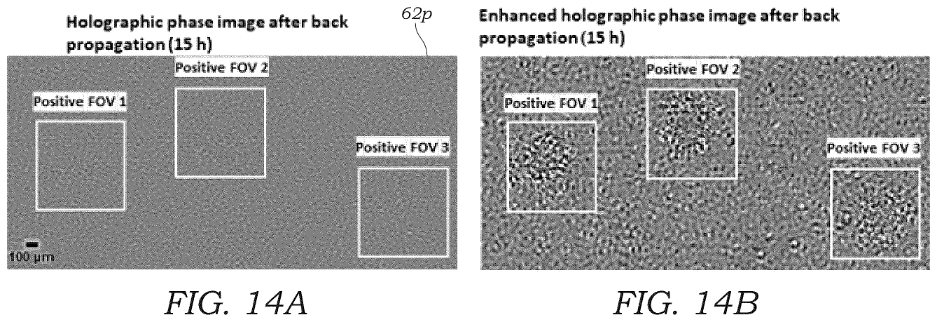

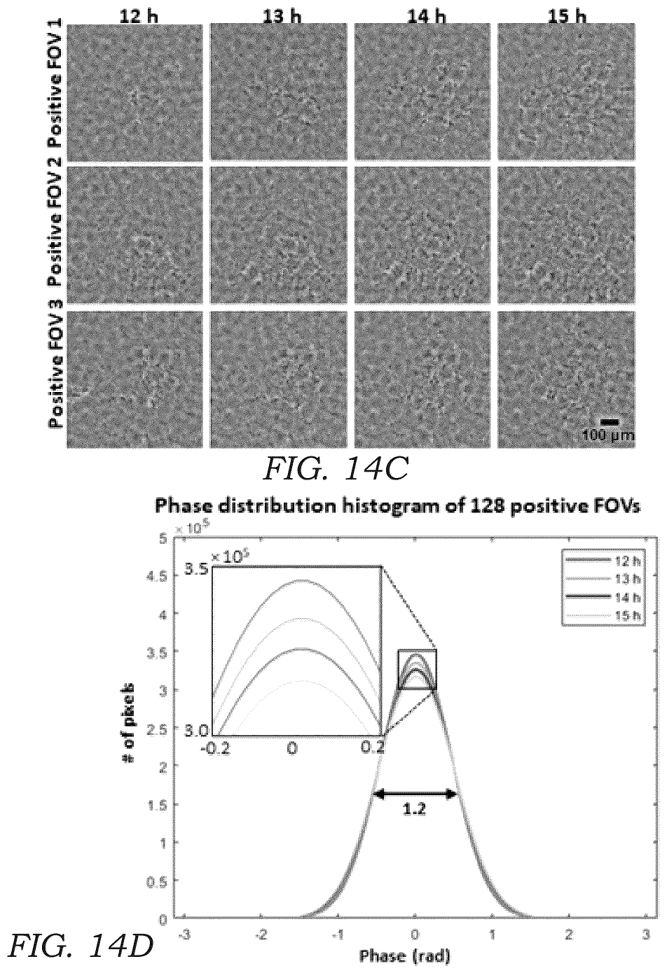

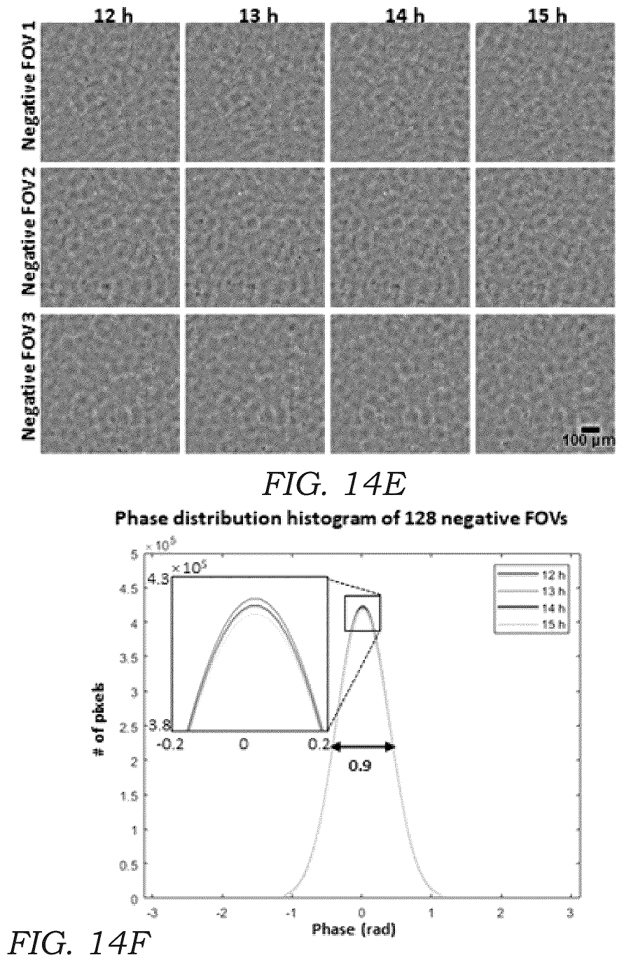

The core of this stain-free PFU detection device 10 lies in the effective combination of digital holography and deep learning. The adoption of the lens-free holographic imaging system is essential for imaging unstained cells within a compact incubator, providing the spatiotemporal phase information of the samples 100 using a compact, cost-effective and high-throughput imaging system. For a given time stamp of the device 10, the PFU regions would in general express a wider phase distribution compared to the non-PFU regions; furthermore, a given PFU region would typically exhibit larger phase changes across different time points (see FIGS. 14A-14F for some examples). These unique spatiotemporal signatures that are present in the phase channel of the holographic label-free time-lapse images 62p are crucial for the deep neural network 54 to statistically identify the target PFU regions from non-PFU regions at earlier time points, without introducing false positives or undercounting due to spatial overlaps. In addition, the large field-of-view (FOV) of the lens-free holographic on-chip imaging configuration with unit fringe magnification, along with its capability for digital focusing without any autofocusing hardware or objective lens helped achieve a large phase information throughput of ˜0.32 Giga-pixels in <30 sec per test well (covering a FOV of ˜30×30 mm²) using a compact and cost-effective device 10 that can fit into any standard incubator without major modifications. This enabled one to rapidly scan an entire 6-well plate within 3 min, and as a result, the device 10 can potentially scan the PFU samples even more frequently than every hour, which might enable further time savings in PFU detection using finer spatiotemporal changes that might be learned with a shorter imaging period. Such an approach would come with the trade-off of requiring substantially more training data and computation time.

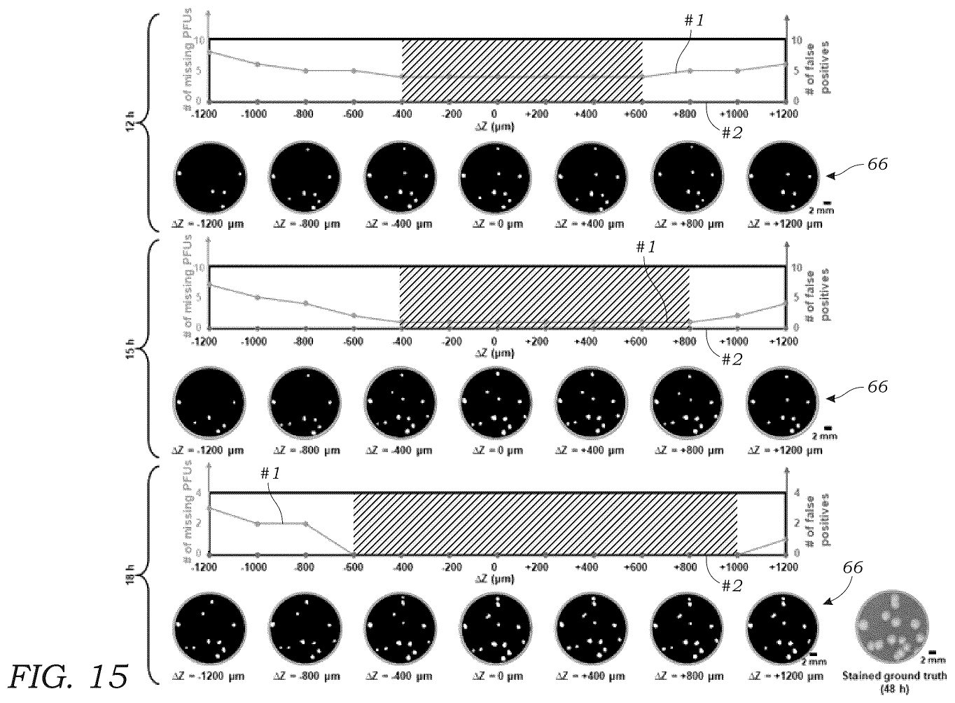

Furthermore, due to the axial defocusing tolerance of the deep learning-based PFU detection method, the image reconstruction steps (spanning several hours of automated time-lapse imaging within an incubator) can be further simplified by propagating the acquired lens-free holograms to a fixed sample-to-sensor axial distance for the entire well without affecting the PFU detection results. This is explained herein in the section entitled “Analysis of the defocusing distance tolerance in the PFU detection system” and illustrated in FIG. 15 that quantifies the defocusing distance tolerance of the device 10.

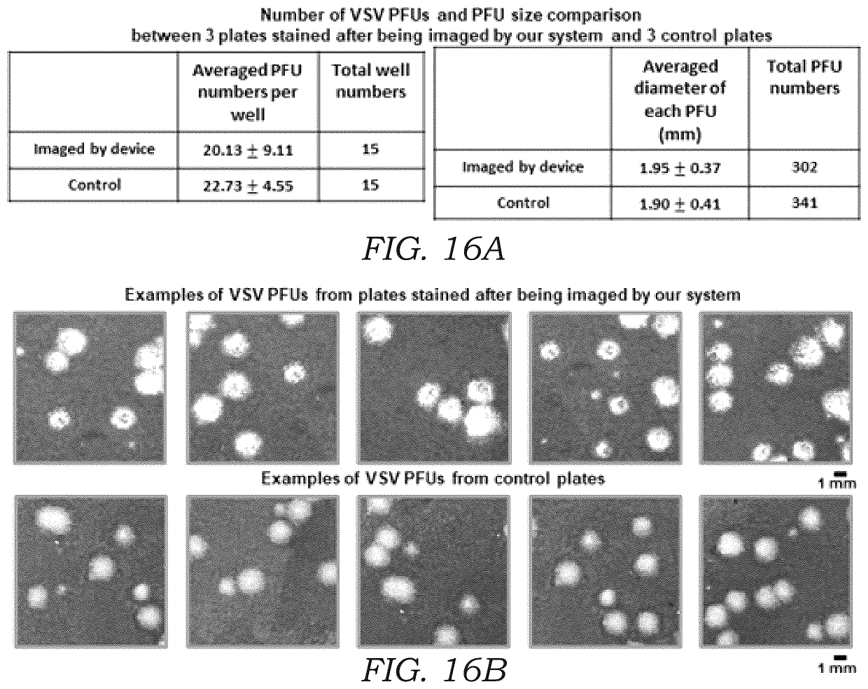

Moreover, the computational holographic PFU detection device 10 requires negligible changes to the standard sample preparation steps employed in traditional plaque assays, while skipping the staining process entirely. The temperature, refractive index and optical field changes within the incubator caused by, for example, evaporation or bubble formation, have negligible influence on the PFU detection performance of this system since such artifacts and statistical variations are learned during the training experiments, helping the trained neural networks 54 differentiate the spatiotemporal features of the true PFUs corresponding to viral replication from such fluctuations and physical perturbations within the incubator environment that naturally occur over several hours. Furthermore, the holographic time-lapse imaging system does not negatively influence or introduce a bias on the plaque formation process within the test wells, which is validated against control experiments as reported in FIGS. 16A and 16B.

The modular design employed by the PFU detection device 10 brings the potential for further system improvements. For example, parallel imaging can be achieved by installing a plurality of image sensors 16 on the same system without significantly increasing the cost of the device 10, which will further improve the 30 cm²/min effective imaging throughput of the device 10. More accurate 2D scanning stages 20 can also help reduce the image registration steps needed during image pre-processing. Multi-wavelength phase recovery using different colored illumination sources 14 can also be implemented to improve the overall image quality of the label-free plaques. The presented deep learning-enabled PFU detection framework can be potentially adapted to other imaging modalities that can provide the spatiotemporal differences in the PFU regions for various types of viruses, similarly, the trained PFU classifier network 54 also has the adaptability to these system changes (see “Guidelines for hyperparameter selection to adapt to other modalities and biological agents” section herein).

In summary, a stain-free, rapid, and quantitative viral plaque assay using deep learning and holography is disclosed. The compact and cost-effective device 10 preserves all the advantages of the traditional plaque assays while substantially reducing the required sample incubation time in a label-free manner, saving time and eliminating staining. It is also resilient to potential artifacts during the sample preparation, and can automatically quantify a larger dynamic range of virus concentrations per well. This technique is expected to be widely used in virology research, vaccine development, and related clinical applications.

### Material and Methods

Safety practices. All the cell cultures and viruses handled during the experiments were done at a biosafety level 2 (BSL2) laboratory according to the environmental, health, and safety rules and regulations of the University of California, Los Angeles. All operations were carried out under strict aseptic conditions.

Studied organisms. Vero C1008 [Vero 76, clone E6, Vero E6](ATCC@CRL-1586TM) (ATCC, USA) and), vesicular stomatitis virus (ATCC@VR-1238TM).), herpes simplex virus type 1 (ATCC VR-260TM) and encephalomyocarditis virus (ATCC VR-129BTM) were used. Vero E6 cells are African green monkey kidney cells and are epithelial cells.

Cell propagation. The frozen stock culture was placed immediately in the liquid nitrogen vapor, until ready for use, just after the delivery of the frozen stock culture from ATCC. ATCC formulated Eagle's Minimum Essential Medium (EMEM) (product no. 30-2003, ATCC, USA) was used as a base medium for the cell line. For the complete growth medium, the base medium was mixed with fetal bovine serum (FBS) (product no. 30-2021, ATCC, USA) with a final concentration of 10%. The FBS stock was aliquoted into 4 mL microcentrifuge tubes and stored at −20° C. until use.

Tissue culture flasks (75 cm² area, vented cap. TC treated, T-75) (product no. FB012937, Fisher Scientific, USA) were used for cell culturing. The base medium in a T-75 flask and FBS were brought to 37° C. in the incubator (product no. 51030400, ThermoFisher Scientific, Waltham, MA, USA) and fed with 5% CO₂ before handling it for cell culturing steps. The complete growth medium was prepared. The frozen cell culture was removed from liquid nitrogen and thawed under running water. After thawing the cells, the cell suspension was added to a T-75 flask containing 8 mL of complete growth medium (i.e., EMEM+10% FBS). The flask was incubated at 37° C. and 5% CO₂ in the incubator. The adherence of the cells to the flask surface was analyzed daily under a phase-contrast microscope. The medium in the flask was renewed 2-3 times a week. The cells were sub-cultivated in a ratio of 1:4 when 95% confluency of the cells as a monolayer was reached.

Subculturing of cells. After the removal of the medium from the cell culture flask, the cells were exposed to 2-3 mL of 0.25% Trypsin/0.53 mM EDTA (ATCC 30-2101TM, ATCC, USA) per flask for dissociation of cell monolayers. The flasks were kept in the incubator for 5-6 minutes for rapid dissociation of cells. 8 mL of complete medium per flask was added to each of them and 2-3 mL of the mixture containing suspended cells was transferred into anew T-75 flask. 8 mL of complete medium was added to the new flask and after gentle mixing, it was incubated at 37° C. and 5% CO₂ for the growth of new cells.

Virus propagation. After the delivery of the virus stock samples from ATCC, they were stored in liquid nitrogen tanks until further use. Virus propagation requires to have Vero cells to be cultured and reach 90-95% confluency on the day of infection. Therefore, Vero cells were cultured for 1-2 days before the virus propagation using a seed cell suspension of Vero cells that were subcultured more than 3 times. On the day of the virus infection, the growth medium in the Vero cell culture flask was removed and discarded. Then, it was rinsed using 5 mL Dulbecco's Phosphate Buffered Saline (D-PBS), 1× (ATCC 30-2200™) (product no. 30-2200, ATCC, USA). After keeping the D-PBS containing flask for 3 min in the cabinet, the buffer solution was removed and discarded. For the virus propagation, the Vero cells in each flask were infected by 14 μL of VSV stock virus, 17 μL of HSV-1 stock virus, or 20 μL of EMCV stock virus with a multiplicity of infection (MOI) of 0.003, 0.07, and 0.05 for the VSV. HSV-1, and EMCV, respectively. Following this. 6 mL of EMEM (without FBS) was added to each flask. The flasks were incubated at 37° C. for 1 hour and rocked at 15 min intervals to have a uniform spread of virus inoculum. After 1 hour, 10 mL of complete medium was added to each flask and the flasks were incubated at 37° C. and 5% CO₂ for 48 h to 72 h.

After the incubation, the flasks were analyzed under a phase-contrast microscope. The cells should dissociate from the surface and round cells should be observed in the mixture if the virus propagation process is successful. The mixture was collected into a 50 mL tube (product no. 06-443-20, Fisher Scientific, USA) and the tubes were sealed using a parafilm layer. The suspension in the tube was centrifuged at ˜2600 g for 10 min using a centrifuge with swing-out rotors (product no. 22500126, Fisher Scientific, USA). The supernatant containing the virus was collected from the tube and pooled in a new tube. After gentle mixing of the tube to have a uniform suspension, the suspension was aliquoted into 1 mL cryogenic vials with O-ring (product no. 5000-1012, Fisher Scientific, USA). The tubes were labelled and stored in liquid nitrogen tanks.

Preparation of agarose solution. 4% Agarose (product no. MP11AGR0050, Fisher Scientific, USA) in reagent grade water (product no. 23-249-581, Fisher Scientific, USA) was prepared and well mixed. The suspension was then aliquoted into the glass bottles. The solution was sterilized at 121° C. for 15 min in an autoclave and 50 mL aliquots were stored at 4° C. until use.

Preparation of agarose overlay solution. One of the tubes containing the 50 mL of sterile agarose solution was heated up in a microwave oven for ˜30 s. The solution was cooled down to 65° C. in a water bath. 23.9 mL EMEM medium was mixed with 0.6 mL FBS and warmed to 50° C. 3.5 mL of agarose solution was added into the warmed medium mixture using a 10 mL—serological pipette and kept at 50° C. until use.

Well plate preparation. First, the adhered cells in the flask were resuspended using trypsin. The solution was gently mixed to have uniform cell suspension and 10 μL of the suspension was taken for cell counting using a hemacytometer chamber. The cells were counted using a phase-contrast microscope. According to the cell count, the concentration of cells was adjusted to ˜6.5×10⁵ cells/mL by diluting the suspension using the complete medium. ˜6.5×10⁵ cells were added to each well of a new 6-well plate. Then, 2 mL of complete medium was added to each well and the plate was stored at 37° C. and 5% CO₂ for 24 h. Next, the cell coverage on each well was checked under the microscope. The cell coverage should reach ˜95% to perform the PFU assay.

For a given 6-well plate, the cells of each well were infected with 100 μL of diluted virus suspension (the dilution factors for VSV, HSV-1, and EMCV are 2⁻¹×10⁻⁶, 2⁻²×10⁻⁵, and 2⁻³×10⁻³ respectively) and ˜2.5-3 mL of the overlay solution was added to the cells. After the solidification of the overlay at room temperature, the plate was incubated in an incubator (Heracell VIOS 160i CO₂ Incubator, Thermo Scientific) for 48 hours, 120 hours and 72 hours corresponding to VSV, HSV-1, and EMCV, respectively. A photo review of the HSV-1 samples at 72 hours, 96 hours and 120 hours of incubation confirms the need for 120 hours of incubation for HSV-1 PFUs. Similarly, a photo comparison of the EMCV samples at 48 hours and 72 hours of incubation confirms the need for 72 hours of incubation for EMCV. These observations are also in line with previous studies.

The preparation of the 12-well plates used for VSV PFU testing followed the same workflow of the 6-well plate VSV preparation. The only difference in preparing 12-well VSV plates is that the seeded cells in each well, the virus suspension volume per well, and the agarose overlay solution used for each well were reduced to half compared with the 6-well plates. The different experimental settings that were used for VSV. HSV-1, and EMCV experiments in the process of virus propagation and well plate preparation is summarized in Table 1 below.

TABLE 1

| | | | Well plate preparation | | | | |
|---|---|---|---|---|---|---|---|
| | Virus propagation | | | Virus | | Agarose | Total |
| | Virus | The | | titers of | Virus | overlay | incubation |
| | solution | multiplicity | | own | suspension | solution | time |
| | volume used | of infection | Dilution | prepared | volume for | for each | (Ground |
| | for infection | (MOI) | factor | stock | each well | well | Truth) |
| VSV | 14 μL | 0.003 | 2⁻¹ × 10⁻⁶ | 6.6 × 10⁸ | 100 μL | 2.5 mL | 48 hours |
| | | | | PFU/mL | (6-well) | (6-well) | |
| | | | | | 50 μL | 1.25 mL | |
| | | | | | (12-well) | (12-well) | |
| HSV-1 | 17 μL | 0.07 | 2⁻² × 10⁻⁵ | 2.1 × 10⁸ | 100 μL | 3 mL | 120 hours |
| | | | | PFU/mL | (6-well) | (6-well) | |
| EMCV | 20 μL | 0.05 | 2⁻³ × 10⁻³ | 4.2 × 10⁶ | 100 μL | 3 mL | 72 hours |
| | | | | PFU/mL | (6-well) | (6-well) | |

Preparation of crystal violet solution. 0.1 g of crystal violet powder (product no. C581-25, Fisher Scientific) was mixed with 40 mL reagent grade water in a 50 mL centrifuge tube. The mixture was gently mixed to dissolve the powder. 10 mL methanol (product no. A452-4, Fisher Scientific) was added to the mixture and stored at room temperature.

Fixation and staining of cells. These steps were only performed for comparison against the device's PFU readings. After 48 h of all VSV incubation, 120 h of HSV-1 incubation, or 72 h of EMCV incubation, the plate was removed from the incubator and the cells were fixed using 0.5 mL methanol/acetic acid solution for 30 min. After 30 min, the wells were washed with water gently to remove the agarose layer. The excess water was removed, and 1 mL of crystal violet (CV) solution was added to each well. The plate with CV was placed into the shaker incubator and mixed at 100 rpm for 30 min. After 30 min of incubation, tap water was used to remove excess stain from the plate and the waste was collected into a large beaker. The plate was left to dry in a fume hood and stored at room temperature by covering with an aluminum foil.

Lens-free imaging set-up. An automatic lens-free PFU imaging device 10 was built to capture the in-line holograms of the samples 100. This set-up includes: 1) a holographic imaging system that includes the one or more illumination sources 14, the sample holder 12, and the one or more image sensors 16, 2) a 2D mechanical scanning stage 20, 3) a cooling system that includes fans 38, 4) a microcontroller 40, and 5) an automatic control program 56. Three green laser diodes operate as the illumination sources 14 (at 515 nm, 2 nm bandwidth. 0.17 mm emission diameter, Osram PLT5510) were used for coherent illumination, where each laser diode 14 illuminates two wells on the same column of the 6-well sample plate. The laser diodes 14 were controlled by a driver 42 (TLC5916, Texas Instruments, Texas, US) and mounted ˜16 cm away from the sample 100. A CMOS image sensor 16 (acA3800-14 μm, Basler A G, Ahrensburg, Germany, 1.67 μm pixel size, 6.4 mm×4.6 mm FOV) was placed ˜5 mm beneath the sample 100 forming a lens-free holographic imaging system. The phase changes in the PFU regions were encoded in the acquired holograms.

There are several factors that affect the spatial resolution of the lens-free holographic imaging system, including 1) the spatial coherence of the illumination: 2) the temporal coherence of the illumination; 3) axial distance between the source aperture and the sample plane (referred to as z₁) and the sample-to-sensor plane distance (z₂), and 4) pixel size of the image sensor 16. As for the illumination source per well, a single-mode laser diode 14 was used with a core size of 9 μm, with z₁≈16 cm between the source plane and the sample plane, which provided sufficient spatial coherence covering the entire sample plane per well. As for the temporal coherence length of the illumination source 14, one has:

$$Δ {L}_{c} \approx \sqrt{\frac{2 ln 2}{π n}} \cdot \frac{{λ}^{2}}{Δλ} = 88.09 μm \qquad ( 1 )$$

where, λ=515 nm and Δλ=2 nm, which is the bandwidth of the laser diode. One can accordingly calculate the effective numerical aperture due to the temporal coherence limit of the illumination light as (NAₜₑₘₚₒᵣₐₗ):

$${NA}_{temporal} = n sin {θ}_{temporal} = n \sqrt{1 - {cos}^{2} {θ}_{temporal}} = n \sqrt{1 - {( \frac{{z}_{2}}{{z}_{2} + Δ {L}_{c}} )}^{2}} \approx 0.1853 \qquad ( 2 )$$

where z₂≈5 mm. This temporal coherence-based NA is lower than the effective numerical aperture that is dictated by the sample-to-sensor distance and the extent of the detector plane, and therefore, the temporal coherence-dictated holographic resolution limit of the system can be approximated as.

$${d}_{coherence} ∝ \frac{λ}{{NA}_{temporal}} = 2.7793 μm \qquad ( 3 )$$

Since the holographic on-chip imaging system has z₁≥≥z₂, it operates under a unit fringe magnification and the native pixel size (1.67 μm) at the sensor plane also casts its own resolution limit due to the pixelation of the acquired holograms, unless pixel super-resolution (PSR) approaches are utilized to digitally reduce the effective pixel size of each holographic frame. In this work, PSR was not utilized as the device 10 acts as a PFU detector by sensing the spatiotemporal changes induced by viral replication events, and therefore a high spatial resolution (e.g., <1-2 μm) reconstruction of holograms was not necessary. In fact, these design choices also helped substantially simplify and speed up the image processing pipeline and eliminate unnecessary data acquisition. Furthermore, the numerical spatiotemporal variations that might be introduced due to pixel super-resolution algorithms as a function of the incubation time might have introduced technical challenges for the learning of the PFU classifier neural networks 54, which is another design consideration was encountered in addition to the simplification of the holographic data acquisition, processing and storage.

The FOV of the CMOS image sensor 16 is ˜0.3 cm², hence mechanical scanning is needed for imaging the whole area of a 6-well plate. A 2D scanning stage 20 was built using a pair of linear translation rails 22, a pair of linear bearing rods and linear bearings 26. 3D printed parts were also used to aid with the housing 18 and joints. Two stepper motors 30, 34 (product no. 1124090, Kysan Electronics. San Jose, CA, USA), driven by two driver chips 44, 46 (DRV8834, Pololu Las Vegas, NV, US), were exploited to enable the CMOS image sensor 16 to perform 2D horizontal movement. This low-cost device 10 carries the CMOS image sensor 16 moving in a raster pattern and images a total of 420 holograms (21 horizontal, 20 vertical, with 15% overlap) in ˜3 min to complete the whole sample scanning. The selected CMOS image sensor 16 could heat up to ≥70° C. during its operation, which could disturb the growth of the sample 100 and vaporize the agarose layer, especially for regions that are near the image sensor 16 parking location between successive holographic scans. Hence, a cooling system was built using fans 38 (QYN1225BMG-A2, Qirssyn, China). The sides of the sample 100 were sealed using parafilm (product no. 13-374-16, Fisher Scientific, Hampton, NH, USA) and opened 4 holes on the top cover to form a gentle ventilation system, which is an inexpensive and easy-to-implement solution to avoid sample drying.

A microcontroller 40 (Arduino Micro, Arduino LLC) was used to control the two stepper motor driver chips 44, 46, the illumination driver chip 42, and a field-effect transistor-based digital switch (used to turn the CMOS image sensor on/off). All these chips along with the digital switch, wires, and capacitors, were integrated on one printed circuit board (PCB) 39, powered by a 6V-1A power adaptor connected to the wall plug.

An automatic control program 56 executed by the computing device 50 with a graphical user interface 70 (see FIG. 7) was developed using the C++ programming language. It can be used to adjust the image capture parameters (e.g., exposure time etc.) of the CMOS image sensor 16 and communicate with the microcontroller 40 to further switch the laser diodes 14 or CMOS image sensor 16 on/off and control the movement of the mechanical scanning system through the 2D scanning stage 20.

All the components along with their unit prices are also summarized in Table 2 below. The cost of the parts of this entire imaging system is ≤$880, excluding the laptop computer 50. At higher volumes of manufacturing, this cost can be further reduced.

TABLE 2

| Component | Unit price | Number | Total price |
|---|---|---|---|
| 515 nm laser diode | $15.36 | 3 | $46.08 |
| Basler CMOS sensor | $584.00 | 1 | $584.00 |
| Stepper motor | $14.00 | 2 | $28.00 |
| Arduino Micro | $22.80 | 1 | $22.80 |
| TLC5916 LED driver | $1.00 | 1 | $1.00 |
| Stepper motor driver | $9.95 | 2 | $19.9 |
| PCB fabrication | $2.00 | 1 | $2.00 |
| Belts | $25.00 | / | $25.00 |
| Acrylic sheet | $25.00 | 2 | $50.00 |
| Mechanical supporting | $50.00 | / | $50.00 |
| parts | | | |
| 3D printing material | $50.00 | / | $50.00 |
| Total | | | $878.78 |

Image pre-processing. After the image acquisition for each time interval, the raw holograms 60 were firstly reconstructed to phase images 62p using the angular spectrum approach based back-propagation. The accurate sample-to-sensor distance was estimated at the central region of each well using an auto-focusing algorithm based on the Tamura-of-Gradient (ToG) metric. The same sample-to-sensor distance was used for the entire well since the neural network-based method can tolerate de-focusing. For whole images, the phase channel of the reconstructed holograms 62p was stitched into the whole FOV image using a correlation-based method and linear blending.

Starting from the second time interval, a 2-step image registration was performed to compensate for the low accuracy of the mechanical 2D scanning stage 20. A coarse whole FOV correlation-based image registration was firstly performed, then a local fine elastic image registration was followed.

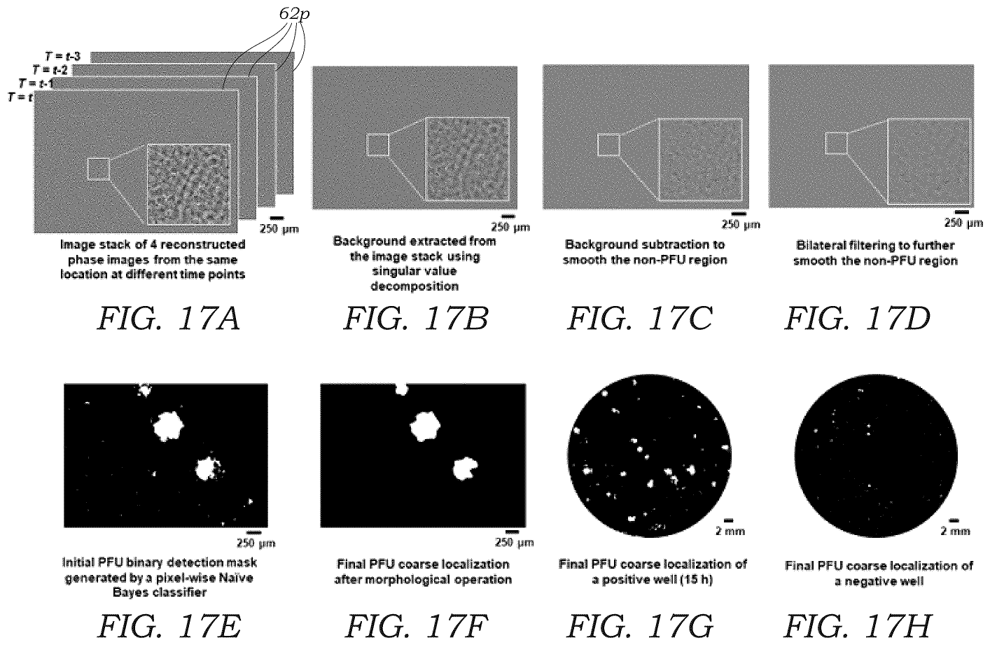

Coarse PFU localization algorithm. First, each current frame was stacked with the previous 3 frames (shown in FIG. 17A) and a background image (shown in FIG. 17B) was estimated through singular value decomposition. By subtracting this background image, signals from the static regions were suppressed (shown in FIG. 17C). Then, by applying bilateral filtering, the PFU regions with high spatial frequency features were further enhanced (shown in FIG. 17D).

93 images patches (256×256 pixels) in PFU regions and 93 image patches from non-PFU regions were cropped manually from 3 experiments. Each pixel of these image patches was labelled as 1 for the PFU region and 0 for the non-PFU region. A Naïve Bayes pixel-wise classifier was trained using this dataset, where the Tamura-of-Gradient (ToG) metric was computed at 2×, 4×, 8×, 16×, and 32× down-sampling scales to serve as the manually selected features. The effect of this classifier is shown in FIG. 17E. Finally, by applying several morphological operations (such as image close, image fill, etc.), the PFU regions are coarsely located (shown in FIG. 17F).

Though this coarse PFU localization algorithm was still subject to detect false positives (shown in FIG. 17G), it could significantly simplify the effort needed for populating the network training dataset. In addition, applying this algorithm to a negative well would help delineate the potential false positives during network training (shown in FIG. 17H). Ultimately, this coarse PFU localization algorithm helped label 357 positive videos and 1169 negative videos used to train the PFU classification network. The positive videos were populated to 2594 by performing augmentation over time; the negative videos were populated to 3028 by further random selection from the negative control wells. Important to note that this PFU localization algorithm was only used for the training data generation, and was not employed in the blind testing phase as its function was to streamline the training data generation process to be more efficient.

Network training dataset. The network training datasets used herein were generated by combining the coarse PFU localization algorithm with human labeling. To obtain the training datasets for VSV, 54 training wells from nine 6-well plates containing 9 negative control wells and 45 positive (virus-infected) wells were imaged and processed. For the positive training dataset, after the image pre-processing, the coarse PFU localization algorithm was applied to the images obtained at 12 hours of incubation. From the 45 positive wells, this process automatically generated 6930 VSV PFU candidates. Then, each of these candidates was examined by four experts using a customized Graphical User Interface. Only those PFU candidates confirmed by all four experts were kept in the positive training dataset; potentially missed PFUs are not a concern here since this is just the training dataset. Ultimately, 357 positive videos of the confirmed PFUs were kept and were further populated to 2594 videos by performing augmentation over time. For the negative training dataset, all the negative videos were populated from the 9 negative control wells. To enhance the specificity of the network 54, the coarse PFU localization algorithm was also applied to the holographic images obtained at 12 hours of incubation. Any detected PFU regions were false positives in this case since these were from the negative control wells. However, such regions might contain unique spatial-temporal features that would potentially confuse the PFU network 54 and thus were kept in the negative training dataset to provide valuable training examples for the deep neural network 54. In total, 1169 such videos were found by this process, and the negative training dataset is further augmented to 3028 videos by random selection from the negative control wells. Following the same dataset generation method, the training datasets of HSV-1 and EMCV that were used for transfer learning were prepared accordingly. The above-mentioned coarse PFU localization algorithm was first applied to 72-hour holographic phase images for HSV-1 and 60-hour holographic phase images for EMCV. For the HSV-1 training dataset, 1058 positive videos of 122 confirmed HSV-1 PFUs from 10 wells, and 1453 negative videos from 2 negative control wells were generated. Similarly, 776 positive videos of 152 EMCV PFUs from 15 wells and 1875 negative videos from 3 negative control wells formed the training dataset for EMCV. Based on the plaque-forming speed for each type of virus, the time intervals between 2 consecutive holographic frames for the VSV videos, HSV-1 videos and EMCV videos were set to 1 hour, 2 hours and 1 hour, respectively.

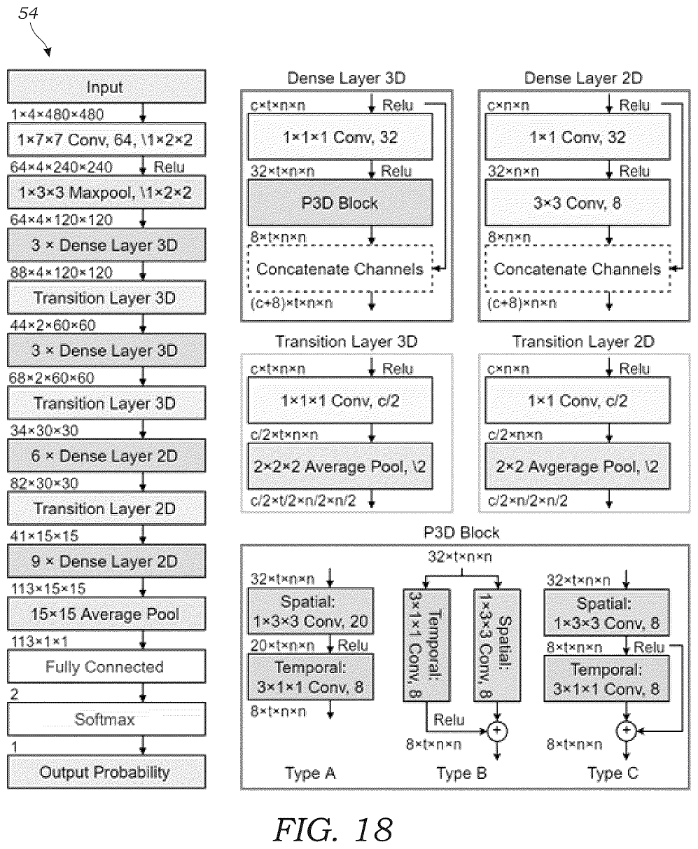

Network architecture and training schedule. The PFU classifier network 54 was built based on the DenseNet structure, with 2D convolution layers replaced by the pseudo-3D building blocks. The detailed architecture is shown in FIG. 18. ReLU was used as the activation function. Batch normalization and dropout with a rate of 0.5 were used in the training. The loss function used was the weighted cross-entropy loss:

$$l ( p , g ) = {\sum }_{k = 1}^{K} {\sum }_{l = 1}^{2} - {w}_{l} \cdot {g}_{k , l} \cdot log ( \frac{exp ( {p}_{k , l} )}{exp ( {p}_{k , 1} ) + exp ( {p}_{k , 2} )} ) \qquad ( 4 )$$

where p is the network output, which is the probability of each class (i.e., PFU or non-PFU) before the SoftMax layer, g is the ground-truth label (which is equal to 0 or 1 for binary classification), K is the total number of training samples in one batch, w is the weight assigned to each class, defined as w=1−d, where d is the percentage of the samples in one class (d=46.1% for positive class, d=53.9% for negative class).

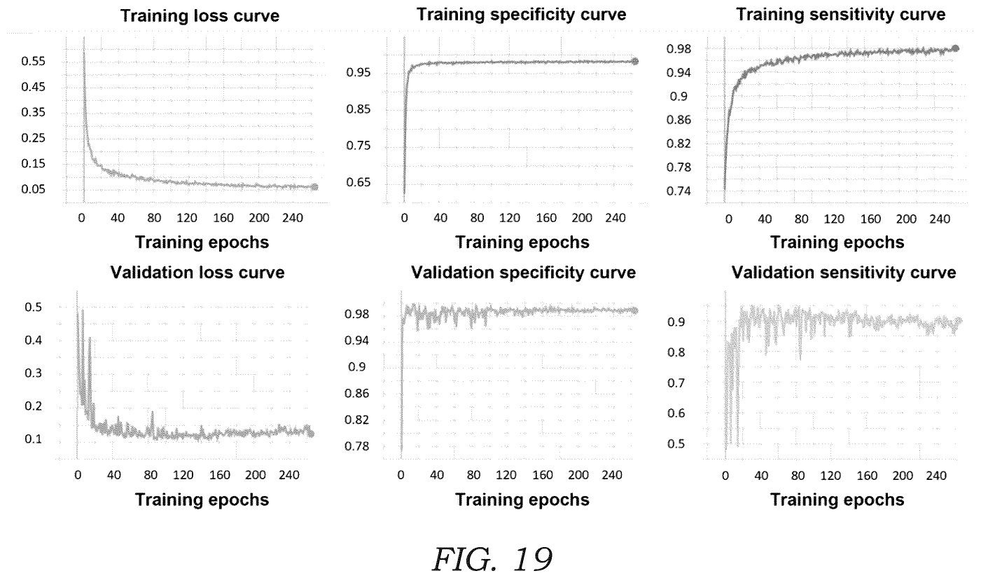

The input 4-frame images 62p were formatted as a tensor with the dimension of 1×4×480×480 (channel×time frame×height×width). Data augmentation, such as flipping, and rotation were applied when loading the training dataset. The network model was optimized using the Adam optimizer with a momentum coefficient of (0.9, 0.999). The learning rate started as 1×10⁻⁴ and a scheduler was used to decrease the learning rate with a coefficient of 0.7 at every 30 epochs. The model was trained for 264 epochs using NVIDIA GeForce RTX3090 GPU with a batch size of 30. The loss curve, training sensitivity and specificity curves of the training process are provided in FIG. 19. In these curves, 10% of the training dataset was randomly selected as the validation dataset. Note that the training and validation datasets (containing holographic videos of the wells) were formed from various wells at different time points of each PFU assay as detailed earlier; therefore, these training and validation sensitivity and specificity curves do not reflect the evaluation of an individual test well that is periodically monitored from the beginning of the incubation. The blind testing results reported in the Results section, however, were acquired by using the trained VSV PFU detection neural network 54 on individual test wells that were continuously monitored from the beginning of the incubation with a sampling period of 1 hour, achieving >90% detection rate for PFUs with 100% specificity in <20 hours.

Similarly, the PFU detection neural networks 54 for HSV-1 and EMCV were built through transfer learning, where the same neural network architecture was used, but initialized with the parameters obtained by the previously trained VSV model. Other training settings for HSV-1 and EMCV models, such as the loss function, initial learning rate, and optimizer, were all kept as same as the VSV model, but the learning rate was decreased with a coefficient of 0.8 every 10 epochs. Finally, the HSV-1 and EMCV models were obtained after 135 epochs and 88 epochs of training, respectively, based on the validation loss.

Image post-processing. After getting the PFU probability map 64 and applying the 0.5 threshold, two image post-processing steps were followed to obtain the final PFU detection image 60 and results: 1) maximum probability projection along time, and 2) PFU size thresholding. The maximum projection was used to compensate for the lower PFU probability values generated from the PFU center when it enters the late stage of its growth. The effect of this maximum projection is illustrated in FIG. 20. The size threshold on the PFU probability map 64 was set to 0.5×0.5 mm².

Automated PFU counting algorithm. After getting the binary PFU detection mask for each test well, an automated PFU counting algorithm that is compatible with both sparse and dense viral samples was developed. First, the connected components in the detection mask at the m-th hour (denoted as Dₘ) were found. Then, the PFU counts for each connected component in Dₘ were calculated by taking the maximum number of connected components that emerged in this region over time.

$${n}_{cc} = {max}_{t = [ 1 , m ]} ( H ( {D}_{t} * C ) ) \qquad ( 4 )$$

where n_{cc} means the PFU count for the examined connected component in Dₘ, Dₜ means the PFU detection mask at t-th hour, C represents a binary map (with the same dimensions as Dₜ) which only maintains the current examined connected component in Dₘ as 1, * means the element-wise multiplication, and H(·) refers to the operation of taking the number of the connected components. Finally, the sum of the n_{cc} for all the connected components in Dₘ was taken as the final PFU count for each well.

Automated PFU counting settings for Biotek Citation 5. For comparison against the device 10, some of the VSV 6-well plates were analyzed using the Biotek Citation 5 (Agilent Technologies, Santa Clara, CA) under the bright-field mode with an objective lens of 4×0.13 NA. These captured images were processed and analyzed using its self-contained Gen5 Image Prime software (Agilent Technologies, Santa Clara, CA). The captured local images were first stitched into a whole FOV image of each test well, which was then processed by the “digital phase contrast” function using a 50 μm structuring element size. Next, the “cellular analysis” tool was used to perform the automated PFU counting. In its basic settings, an intensity threshold of 2500 and an object size threshold of 1500-5000 μm were used. And in its advanced detection settings, the rolling ball diameter of the background flattening, image smoothing strength, and the evaluated background level were set to 1000 μm, 20 cycles of 3×3 average filter, and 30% of the lowest pixels, respectively. All the parameters used for pre-processing and automated PFU counting were optimized in consultation with the technical support team from Agilent Technologies.

PFU detection rate and the false discovery rate. To evaluate the PFU detection performance of the device 10, the detection rate and the false discovery rate were defined as follows.

$$Detection rate = \frac{TP}{GT} \qquad ( 6 )$$

where TP (true positives) represents the number of the detected PFUs by the device 10 at a given time point within the incubator; GT (ground truth) is the total PFU number counted by an expert for the same sample after 48 hours of VSV incubation (120 hours for HSV-1 and 72 hours for EMCV) followed by the standard staining as part of the traditional plaque assay protocol. For false discovery, the following was used:

$$False discovery rate = \frac{FP}{TP + FP} \qquad ( 7 )$$

where FP stands for false positives.

Analysis of the effect of the decision threshold on the PFU detection results. In the results shown in FIGS. 3A-3C, an unbiased decision threshold of 0.5 was chosen to convert the PFU probability maps to the binary final PFU detection masks. To further analyze the effect of this threshold, the same 30 test wells (including 5 negative wells and 25 positive wells infected by VSV) used in FIG. 3C were tested using different thresholds ranging from 0.1 to 0.9, and summarized the results in FIGS. 9A-9C. Overall, these different decision thresholds resulted in a trade-off between the sensitivity and the specificity of the PFU detection system. A stricter (i.e., higher) decision threshold would improve the specificity of the system and guarantee a zero false discovery rate (FIG. 9C), but also harm the sensitivity of the system and lower the detection rate (FIG. 9B). Here, the selection of 0.5 as the decision threshold ensured a zero false discovery rate, still maintaining a high detection rate, successfully detecting PFUs in their early stage (i.e., small size) without having any false positives.

Guidelines for hyperparameter selection to adapt to other modalities and biological agents. The device 10 may be adapted to different imaging modalities that can provide spatiotemporal differences in the PFU regions for various types of biological agents. Here, the principles of the system hyperparameter selection is discussed, particularly the 0.8×0.8 mm² network input window size, and the network input frames, to provide a guideline for future applications.

The selection of the window size should take into account the system resolution, PFU size, and network structure. The input window size to the PFU detection network 54 should be approximately one order of magnitude larger compared to the resolution of the imaging system to provide sufficient spatial information to the network 54. On the other hand, if the window size is too large, it will dramatically decrease the network inference speed and harm its ability to differentiate PFU clusters at an earlier time point. Lastly, the number of pixels for the window must be divisible by 32, since the selected network structure will down-sample the input images by 32 times; of course, the network structure can be modified accordingly to handle a different number of pixels at the input depending on the needs. Combining all these, the 480×480 pixels, i.e., 0.8×0.8 mm² window size was chosen in the PFU detection network 54.

For the selection of the number of input frames 62a, 62p, the experience is that at least three (3) time-lapse frames must be fed into the network to differentiate an early-stage PFU from other non-specific signals. To increase the stability of the network performance and ensure its efficiency, four (4) frames were used (acquired at a period of 1 hour) as the network input. However, this number is subject to increase when the 1-h scanning time interval is reduced. This should be ultimately decided by whether sufficient spatiotemporal features can be captured when adapting to different types of viruses depending on the corresponding plaque formation speed.

Analysis of the defocusing distance tolerance in the PFU detection system. During the holographic image reconstruction, one fixed sample-to-sensor distance (estimated from the center of each well) was used to focus and back-propagate the raw holograms for each well. To explore the defocusing tolerance of the device 10 at different time points, the whole field-of-view reconstructed holographic image of a test well at 12 hours, 15 hours, and 18 hours of incubation were digitally propagated to several defocused planes ranging from ˜1200 μm to 1200 μm with a step size of 200 μm. Following this, the PFU classifier network 54 was blindly applied to all of these on-purpose defocused images to obtain the PFU probability maps 64 and final detection results after thresholding by 0.5, as before. The final PFU detection results (including the visualized illustrations, the number of missing PFUs, and the number of false positives) at these different defocusing distances compared to the stained ground truth at 48 hours are demonstrated in FIG. 15. It was found out that the detection results would maintain the same performance when the defocusing distance ranges from −400 μm to 600 μm, from −400 μm to 800 μm, and from −600 μm to 1000 μm for 12 hours, 15 hours, and 18 hours of incubation, respectively, suggesting that the presented system has a large defocusing tolerance. Since the largest axial deviation within one well was −300 μm (computed from all of the samples), propagating the acquired lens-free holograms using a single fixed distance for the whole test well is sufficient for correct PFU detection.

Network architecture of the PFU decision neural network. Dense layers and transition layers were connected alternatively to transfer the high-dimensional data into low-dimensional data. For each dense layer taking 4-dimensional input, a 3D convolutional layer with a kernel size of (1,1,1) and a stride of (1,1,1) was first applied to reduce the number of channels to 32, and the pseudo-3D block (sequentially selected from the 3 types (A, B, C) shown in FIG. 18) was followed to further extract both the spatial and temporal features, the output of which was then concatenated with the original input, following the structure of DenseNet. Each transition layer also reduced the number of channels of its input by half using a 3D convolutional layer with a kernel size of (1,1,1) and a stride of (1,1,1), and then an average pooling layer with a kernel size of (2,2,2) and a stride of (2,2,2) was followed to reduce the image size by half. 2D versions of the dense and transition layers were included, which were only used to process the spatial domain in the case when the temporal dimension was collapsed to 1. In total, the network consists of six (6) 3D dense layers, two (2) 3D transition layers, fifteen (15) 2D dense layers, and one (1) 2D transition layer. Lastly, an average spatial pooling layer was used with a kernel size of (15,15) to flatten the features into a 113-length vector, which was then fed into a fully connected layer and SoftMax layer to produce an output PFU probability map 64.

While embodiments of the present invention have been shown and described, various modifications may be made without departing from the scope of the present invention. For example, while the device 10 has largely focused on the use of reconstructed phase images 62p, in other embodiments, amplitude images 62p may be input to the trained neural network 54. The invention, therefore, should not be limited, except to the following claims, and their equivalents.

1. A device for performing an automated viral plaque assay of a sample comprising:
a sample holder comprising one or more wells or sample-holding regions formed therein and configured to incubate the sample with cells contained in the one or more wells or sample-holding regions;
one or more illumination sources disposed on one side of the sample holder and configured to illuminate the sample holder;
one or more image sensors disposed on an opposing side of the sample holder and configured to capture holographic images of the one or more wells or sample-holding regions over a plurality of incubation times, wherein the one or more image sensors and/or the sample holder is/are moveable relative to one another; and
a computing device executing image processing software configured to reconstruct the holographic images into phase and/or amplitude images, the image processing software further comprising a trained neural network configured receive the phase and/or amplitude images obtained over the plurality of incubation times and generate an output PFU image identifying plaque-forming units (PFUs) and/or virus-infected areas for the one or more wells or sample-holding regions.

2. The device of claim 1, wherein the trained neural network first generates a PFU probability map of the one or more wells or sample-holding regions followed by a thresholding operation to generate the output PFU image.

3. The device of claim 1, wherein the phase and/or amplitude images comprise local or whole field-of-view (FOV) images of a region of the one or more wells or sample-holding regions.

4. The device of claim 1, wherein the PFUs and/or virus-infected areas are identified in the output PFU image within ≤˜5 hours of sample incubation.

5. The device of claim 1, further comprising at least one microcontroller configured to control one or more of: the one or more illumination sources, motion of the one or more image sensors, motion of the sample holder, and holographic image capture by the one or more image sensors.

6. The device of claim 1, wherein the image processing software is configured to automatically count/measure the number and/or size of PFUs and/or virus-infected areas in each of the one or more wells or sample-holding regions.

7. The device of claim 1, wherein the image processing software is configured to output a virus concentration of the sample.

8. The device of claim 1, wherein a plurality of image sensors capture holographic images of the one or more wells or sample-holding regions over a plurality of incubation times in parallel.

9. The device of claim 1, wherein the one or more illumination sources comprise multiple wavelengths or wavelength ranges.

10. The device of claim 1, further comprising one or more fans configured to direct air over the sample holder.

11. A method of performing an automated viral plaque assay with a sample comprising:
providing a sample holder comprising one or more wells or sample-holding regions formed therein containing cells incubated with the sample;
illuminating the sample holder with one or more illumination sources at a plurality of different incubation times;
capturing holographic images of the one or more wells or sample-holding regions over the plurality of incubation times with one or more image sensors disposed on an opposing side of the sample holder as the one or more illumination sources; and
executing image processing software configured to reconstruct the holographic images into phase and/or amplitude images that are input into a trained neural network configured receive the phase and/or amplitude images over the plurality of incubation times and generate an output PFU image identifying plaque-forming units (PFUs) and/or virus-infected areas for the one or more wells or sample-holding regions.

12. The method of claim 11, wherein the one or more image sensors and/or the sample holder is/are moveable relative to one another.

13. The method of claim 11, wherein the PFUs and/or virus-infected areas are identified in the output PFU image within ≤˜5 hours of sample incubation.

14. The method of claim 11, wherein the image processing software automatically counts/measures the number and/or size of PFUs and/or virus-infected areas in each of the one or more wells or sample-holding regions.

15. The method of claim 11, wherein the image processing software outputs a virus concentration of the sample.

16. The method of claim 11, wherein a plurality of image sensors capture holographic images of the one or more wells or sample-holding regions over a plurality of incubation times in parallel.

17. The method of claim 11, wherein the one or more illumination sources comprise multiple wavelengths or wavelength ranges.

18. The method of claim 11, wherein the trained neural network first generates a PFU probability map of the one or more wells or sample-holding regions followed by a thresholding operation to generate the output PFU image.

19. The method of claim 11, wherein the phase and/or amplitude images comprise local or whole field-of-view (FOV) images of a region of the one or more wells or sample-holding regions.

20. The method of claim 11, further comprising one or more fans configured to direct air over the sample holder.
